(19) United States
(12) Patent Application Publication
(10) Pub. No.: US 2026/0169467 A1
(43) Pub. Date: Jun. 18, 2026

(54) SUBSTRATE PROCESSING APPARATUS

(71) Applicant: EBARA CORPORATION, Tokyo (JP)

(72) Inventors: Mitsuru MIYAZAKI, Tokyo (JP); Katsuhide WATANABE, Tokyo (JP); Satoshi YAMANAKA, Tokyo (JP); Kenichi KOBAYASHI, Tokyo (JP)

(21) Appl. No.: 19/364,917

(22) Filed: Oct. 21, 2025

(30) Foreign Application Priority Data
Oct. 24, 2024 (JP) 2024-187258

(51) Int. Cl. G05B 19/418

(52) U.S. Cl. CPC G05B 19/4189; G05B 2219/45031; G05B 2219/45096

(57) ABSTRACT

Disclosure relates to a substrate processing apparatus that can quickly transport a substrate to a cleaning module after surface processing of the substrate is performed. The substrate processing apparatus includes processing units each for processing a substrate and a relay transporter that transports the substrate between the processing units. Each processing unit includes a surface-processing module, a cleaning module, a drying module, a substrate transporter extending from one side to opposite side of each processing unit, and a processing transporter that transports the substrate from the substrate transporter to the surface-processing module and from the surface-processing module to the cleaning module.

### CROSS REFERENCE TO RELATED APPLICATION

This document claims priority to Japanese Patent Application No. 2024-187258 filed Oct. 24, 2024, the entire contents of which are hereby incorporated by reference.

### BACKGROUND

In manufacturing of semiconductor devices, many types of materials are repeatedly formed on a wafer to form a multilayered structure. In order to form the multilayered structure, a polishing module is used. A substrate processing apparatus includes the above-mentioned polishing module, a cleaning module for cleaning a polished wafer, and a drying module for drying a cleaned wafer. The wafer polished by the polishing module is transported by a transfer robot to the cleaning module and the drying module, so that the wafer is cleaned and dried by the cleaning module and the drying module.

In order to polish a wafer in multiple stages or simultaneously polish a plurality of wafers, the substrate processing apparatus may include a plurality of polishing modules. However, when many polishing modules are installed, a certain polishing module is located at a longer distance from the cleaning module than other polishing modules, and therefore it may take a longer time to transport a polished wafer to the cleaning module.

### SUMMARY

There is provided a substrate processing apparatus that can quickly transport a substrate (e.g., a wafer) to a cleaning module after surface processing (e.g., polishing) of the substrate is performed.

Embodiments, which will be described below, relate to a substrate processing apparatus for processing a substrate, such as wafer, circular substrate, quadrangular substrate, or panel, used for semiconductor devices, and more particularly relates to a substrate processing apparatus including a plurality of surface-processing modules.

In an embodiment, there is provided a substrate processing apparatus comprising: a first processing unit and a second processing unit each for processing a substrate; and a relay transporter configured to transport the substrate between the first processing unit and the second processing unit, wherein each of the first processing unit and the second processing unit comprises: a surface-processing module configured to perform surface processing on the substrate; a cleaning module configured to clean the substrate; a drying module configured to dry the cleaned substrate; a substrate transporter extending from one side to opposite side of each processing unit, and a processing transporter configured to transport the substrate from the substrate transporter to the surface-processing module, and from the surface-processing module to the cleaning module, wherein the surface-processing module of one of the first processing unit and the second processing unit is any one of: a CMP module configured to chemically mechanically polish a surface of the substrate; a bevel polishing module configured to polish a peripheral edge of the substrate; a partial polishing module configured to polish a portion of the surface of the substrate; a backside polishing module configured to polish a backside of the substrate; and a thinning module configured to thin the substrate by grinding the substrate, wherein the surface-processing module of other of the first processing unit and the second processing unit is any one of: the bevel polishing module; the partial polishing module; the backside polishing module; and the thinning module.

In an embodiment, there is provided a substrate processing apparatus comprising: a first processing unit, a second processing unit, and a third processing unit each configured to process a substrate; a first relay transporter configured to transport the substrate between the first processing unit and the second processing unit; and a second relay transporter configured to transport the substrate between the second processing unit and the third processing unit, wherein each of the first processing unit, the second processing unit, and the third processing unit comprises: a surface-processing module configured to perform surface processing on the substrate; a cleaning module configured to clean the substrate; a drying module configured to dry the cleaned substrate; a substrate transporter extending from one side to opposite side of each processing unit, and a processing transporter configured to transport the substrate from the substrate transporter to the surface-processing module, and from the surface-processing module to the cleaning module, wherein the surface-processing module of one of the first processing unit, the second processing unit, and the third processing unit is any one of: a CMP module configured to chemically mechanically polish a surface of the substrate; a bevel polishing module configured to polish a peripheral edge of the substrate; a partial polishing module configured to polish a portion of the surface of the substrate; a backside polishing module configured to polish a backside of the substrate; and a thinning module configured to thin the substrate by grinding the substrate, wherein the surface-processing module of other one of the first processing unit, the second processing unit, and the third processing unit is any one of: the CMP module; the bevel polishing module; the partial polishing module; the backside polishing module; and the thinning module, and wherein the surface-processing module of remaining one of the first processing unit, the second processing unit, and the third processing unit is any one of: the bevel polishing module; the partial polishing module; the backside polishing module; and the thinning module.

According to the present invention, each of the first processing unit and the second processing unit includes the surface-processing module, the cleaning module, and the processing transporter, so that surface processing and cleaning of a substrate can be completed within each processing unit.

### BRIEF DESCRIPTION OF THE DRAWINGS

FIG. 1 is a perspective view showing an embodiment of a substrate processing apparatus;

FIG. 2 is a side view of the substrate processing apparatus shown in FIG. 1;

FIG. 3 is a plan view of the substrate processing apparatus shown in FIG. 1;

FIG. 4 is a diagram showing an embodiment of a processing transporter;

FIG. 5 is a diagram showing an embodiment of a relay transporter;

FIG. 6A is a side view showing an embodiment of a substrate transporter, and FIG. 6B is a cross-sectional view taken along line A-A in FIG. 6A;

FIG. 7A is a side view showing another embodiment of the substrate transporter, and FIG. 7B is a cross-sectional view taken along line B-B in FIG. 7A;

FIG. 8 is a side view showing still another embodiment of the substrate transporter;

FIG. 9 is a side view showing still another embodiment of the substrate transporter;

FIG. 10A is a side view showing still another embodiment of the substrate transporter, and FIG. 10B is a cross-sectional view taken along line C-C in FIG. 10A;

FIG. 11A is a side view showing still another embodiment of the substrate transporter, and FIG. 11B is a cross-sectional view taken along line D-D in FIG. 11A;

FIG. 12 is a perspective diagram showing an embodiment of a partial-polishing module;

FIG. 13 is a diagram showing an example of a substrate transportation route and a processing sequence;

FIG. 14 is a diagram showing another example of the substrate transportation route and the processing sequence;

FIG. 15 is a diagram showing still another example of the substrate transportation route and the processing sequence;

FIG. 16 is a graph showing changes in a first maintenance index value and a second maintenance index value over time;

FIG. 17 is a graph showing an example in which maintenance times of the first processing unit and the second processing unit overlap;

FIG. 18 is a graph illustrating an embodiment of avoiding the overlapping of the maintenance times by increasing an operating rate of the first processing unit;

FIG. 19 is a graph illustrating an embodiment of avoiding the overlapping of the maintenance times by reducing an operating rate of the second processing unit;

FIG. 20 is a graph illustrating an embodiment of avoiding the overlapping of the maintenance times by increasing the operating rate of the first processing unit and reducing the operating rate of the second processing unit;

FIG. 21 is a plan view showing another embodiment of the substrate processing apparatus;

FIG. 22 is a side view showing an embodiment of a configuration of a bevel polishing module;

FIG. 23 is a plan view showing still another embodiment of the substrate processing apparatus;

FIG. 24 is a plan view showing still another embodiment of the substrate processing apparatus;

FIG. 25 is a plan view showing still another embodiment of the substrate processing apparatus;

FIG. 26 is a side view showing an embodiment of a configuration of a backside polishing module;

FIG. 27 is a plan view showing still another embodiment of the substrate processing apparatus;

FIG. 28 is a side view showing an embodiment of a configuration of a thinning module;

FIG. 29 is a plan view showing still another embodiment of the substrate processing apparatus;

FIG. 30 is a diagram showing an example of a substrate transportation route and a processing sequence; and

FIG. 31 is a diagram showing another example of the substrate transportation route and the processing sequence.

### DESCRIPTION OF EMBODIMENTS

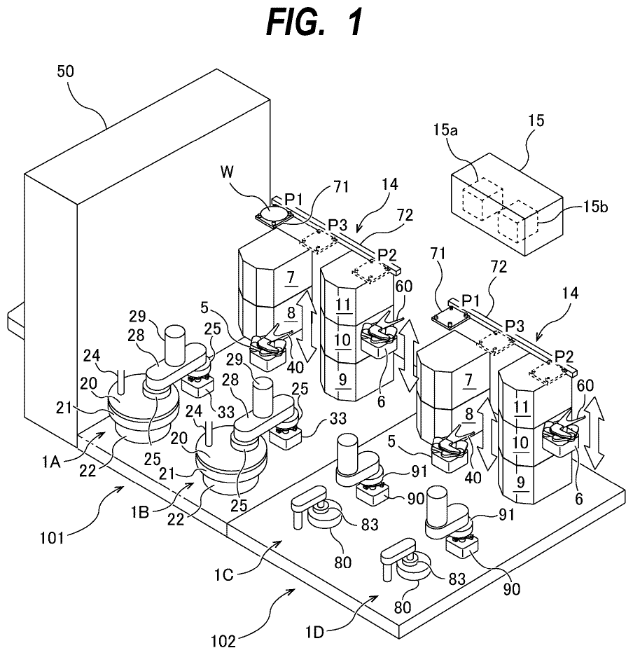

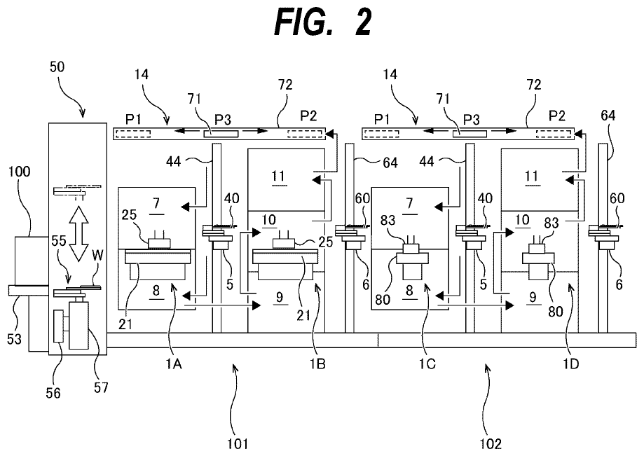

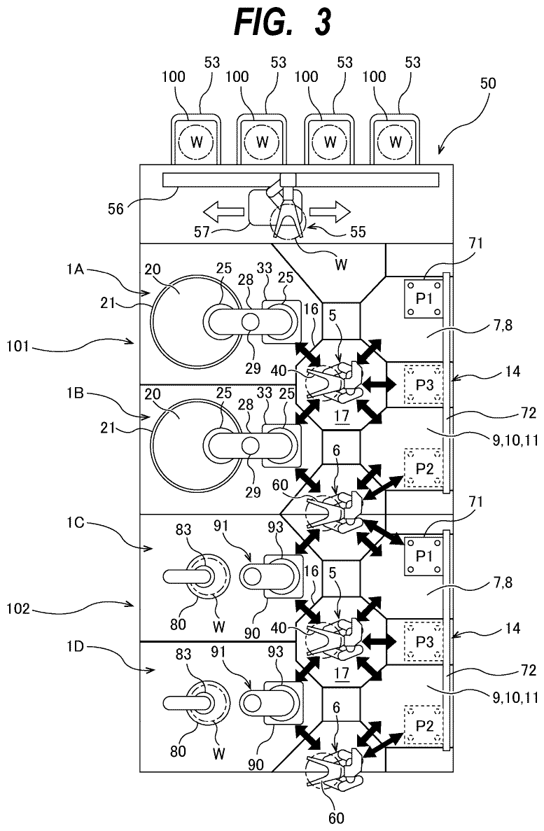

Hereinafter, embodiments will be described with reference to the drawings. FIG. 1 is a perspective view showing an embodiment of a substrate processing apparatus, FIG. 2 is a side view of the substrate processing apparatus shown in FIG. 1, and FIG. 3 is a plan view of the substrate processing apparatus shown in FIG. 1. The substrate processing apparatus includes a first processing unit 101 and a second processing unit 102 each configured to process a substrate W. Processing of the substrate W includes polishing (or grinding), cleaning, and drying of the substrate W. The first processing unit 101 and the second processing unit 102 are arranged side by side. Specific examples of the substrate W include wafer, circular substrate, quadrangular substrate, panel, etc. used for semiconductor devices. In the embodiments described below, a circular wafer is used as the substrate W.

Each of the first processing unit 101 and the second processing unit 102 is a unitized assembly. In one embodiment, the second processing unit 102 is removably coupled to the first processing unit 101 such that the entirety of the second processing unit 102 is separable from the first processing unit 101. Furthermore, it is possible to couple one or more additional processing units to the second processing unit 102. Specifically, three or more processing units including the first processing unit 101 and the second processing unit 102 may be coupled in series.

The substrate processing apparatus includes an operation controller 15 configured to control operations of the first processing unit 101 and the second processing unit 102. The operations of the plurality of processing units including the first processing unit 101 and the second processing unit 102 are controlled by the operation controller 15.

The operation controller 15 includes a memory 15a that stores programs therein, and an arithmetic device 15b configured to execute arithmetic operations according to instructions included in the programs. The operation controller 15 is composed of at least one computer. The memory 15a includes a main memory, such as a random access memory (RAM), and an auxiliary memory, such as a hard disk drive (HDD) or a solid state drive (SSD). Examples of the arithmetic device 15b include a CPU (central processing unit) and a GPU (graphic processing unit). However, the specific configuration of the operation controller 15 is not limited to these examples.

In the embodiments shown in FIGS. 1 to 3, the first processing unit 101 includes CMP modules 1A and 1B as surface-processing modules each configured to perform surface processing of the substrate W, and the second processing unit 102 includes partial polishing modules 1C and 1D as surface-processing modules each configured to perform surface processing of the substrate W.

The CMP modules 1A and 1B are polishing apparatuses each configured to chemically and mechanically polish the surface of the substrate W. More specifically, the CMP modules 1A and 1B are configured to chemically and mechanically polish an entirety of a device surface (i.e., a surface on which devices are formed or are to be formed) of the substrate W. The partial polishing modules 1C and 1D are polishing apparatuses each configured to locally polish a portion of the surface of the substrate W. More specifically, the partial polishing modules 1C and 1D are configured to alter a thickness profile of the substrate W by polishing only a portion of the device surface of the substrate W. Accordingly, the surface-processing modules of the first processing unit 101 are of different type from the surface-processing modules of the second processing unit 102.

The configurations of the first processing unit 101 and the second processing unit 102 are the same except for the CMP modules 1A and 1B and the partial polishing modules 1C and 1D. Accordingly, the following description of the configurations of the first processing unit 101 other than the CMP modules 1A and 1B applies to the second processing unit 102 as well.

In the embodiment shown in FIGS. 1 to 3, the first processing unit 101 includes the two CMP modules 1A and 1B, which serve as surface-processing modules, arranged in parallel at the same level (or height). The second processing unit 102 includes the two partial polishing modules 1C and 1D, which serve as surface-processing modules, arranged in parallel at the same level (or height). In one embodiment, each of the processing units 101 and 102 may include a single surface-processing module, or in another embodiment, each of the processing units 101 and 102 may include three or more surface-processing modules arranged in parallel at the same level (or height).

Details of the first processing unit 101 will be described below. The first processing unit 101 includes the CMP modules 1A and 1B each configured to chemically and mechanically polish the surface of the substrate W, a plurality of cleaning modules 7, 8, 9, and 10 each configured to clean the substrate W, a drying module 11 configured to dry the cleaned substrate W, a substrate transporter 14 that extends from one side to opposite side of the first processing unit 101, and a processing transporter 5 configured to transport the substrate W from the substrate transporter 14 to the CMP modules 1A and 1B, and from the CMP modules 1A and 1B to the plurality of cleaning modules 7, 8, and 9. The processing transporter 5 is configured to transport the substrate W among the cleaning modules 7, 8, 9, and 10.

The first processing unit 101 further includes a relay transporter 6 configured to transport the substrate W from the cleaning module 10 to the drying module 11 and from the drying module 11 to the substrate transporter 14. The relay transporter 6 of the first processing unit 101 is configured to transport the substrate W between the first processing unit 101 and the second processing unit 102.

As shown in FIG. 3, the CMP modules 1A, 1B, the processing transporter 5, the relay transporter 6, the cleaning modules 7, 8, 9, 10, and the drying module 11 are surrounded by a wall (housing) 16, so that cleanliness is controlled to prevent atmosphere inside the wall 16 from spreading to other areas. The substrate W is transported through an opening (including a shutter) provided in the wall (housing) 16. In particular, the CMP modules 1A, 1B are partitioned from the cleaning modules 7, 8, 9, 10 by a transfer area 17 having the processing transporter 5 therein. The transfer area 17 is formed by the wall (casing) 16. In FIGS. 1 and 2, detailed illustration of the wall (housing) 16 is omitted.

The CMP modules 1A and 1B are arranged in parallel at the same level (or height). The substrate transporter 14 of the processing unit 101 is arranged at a higher position than the CMP modules 1A, 1B, the cleaning modules 7, 8, 9, 10, and the drying module 11. In this embodiment, the substrate transporter 14 is arranged above the cleaning modules 7, 8, 9, and 10 and the drying module 11.

The processing transporter 5 includes a holding hand 40 configured to be accessible to the substrate transporter 14, the CMP modules 1A, 1B, and the cleaning modules 7, 8, 9, and 10. The holding hand 40 is configured to be movable up and down as indicated by arrow in FIG. 1. The relay transporter 6 of the first processing unit 101 includes a holding hand 60 configured to be accessible to the CMP module 1B, the cleaning module 9, 10, the drying module 11, and the substrate transporter 14 of the first processing unit 101, and the substrate transporter 14, the partial polishing module 1C, and the cleaning modules 7 and 8 of the second processing unit 102. The holding hand 60 is configured to be movable up and down as indicated by arrow in FIG. 1.

The substrate W to be polished is transported by the substrate transporter 14 of the first processing unit 101 with the surface of the substrate W to be polished facing upward. The processing transporter 5 of the first processing unit 101 ascends to the substrate transporter 14 and removes the substrate W from the substrate transporter 14. Furthermore, the processing transporter 5 inverts the substrate W such that the surface to be polished of the substrate W faces downward, and then transports the substrate to one of the CMP modules 1A and 1B. The substrate W is polished by one or both of the CMP module 1A and the CMP module 1B. The substrate W is transported between the CMP modules 1A and 1B by the processing transporter 5.

Since the two CMP modules 1A and 1B have the same components, the CMP module 1A will be described below. The CMP module 1A includes a polishing table 21 configured to support a polishing pad 20, a table motor 22 configured to rotate the polishing table 21, a polishing-liquid supply nozzle 24 configured to supply a polishing liquid onto the polishing pad 20, two polishing heads 25, 25 each configured to press a substrate W against the polishing pad 20 to polish the substrate W, and polishing-head motors (not shown) configured to rotate the polishing heads 25, 25 about their axes, respectively. The two polishing heads 25, 25 are rotatably supported by a head arm 28. The polishing-head motors are disposed in the head arm 28. A central portion of the head arm 28 is supported by a support shaft 29.

The CMP module 1A further includes a substrate loader 33 configured to receive the substrate W from the processing transporter 5 and transfer the substrate W to one of the two polishing heads 25, 25. The substrate loader 33 is arranged outside the polishing table 21. The processing transporter 5 is configured to invert the substrate W such that the surface to be polished of the substrate W faces downward, and transport the substrate W to the substrate loader 33 with the surface to be polished of the substrate W facing downward.

The CMP module 1A further includes an arm rotation motor (not shown) configured to rotate the head arm 28 and the two polishing heads 25, 25 about the support shaft 29. This arm rotation motor is installed on the head arm 28 or the support shaft 29. When the head arm 28 is rotated by an angle of 180 degrees by the arm rotation motor, one of the two polishing heads 25, 25 is moved to a position above the polishing pad 20, and the other polishing head 25 is moved to a position above the substrate loader 33. The substrate loader 33 is configured to lift the substrate W and transfer the substrate W to the polishing head 25 located outside the polishing table 21. The polishing heads 25, 25 are configured to be able to hold the substrate W on their lower surfaces by vacuum suction. In one embodiment, one or both of CMP modules 1A, 1B may have a single polishing head 25.

The polishing of the substrate W is performed as follows. When the substrate W to be polished is held by the polishing head 25, the head arm 28 rotates 180 degrees, so that the polishing head 25 moves together with the substrate W to the position above the polishing pad 20. The polishing table 21 and the polishing pad 20 are rotated by the table motor 22, and the polishing liquid (typically slurry) is supplied onto the polishing pad 20 from the polishing-liquid supply nozzle 24. The polishing head 25 presses a lower surface (surface to be polished) of the substrate W against the polishing pad 20 while the polishing head 25 is rotated by the polishing-head motor (not shown) disposed in the head arm 28. The lower surface of the substrate W is polished by a combination of a chemical action of the polishing liquid and a mechanical action of the abrasive grains contained in the polishing liquid and/or the polishing pad 20. The CMP modules 1A and 1B of this embodiment are chemical mechanical polishing apparatuses (CMP apparatuses) that chemically mechanically polish the substrate W.

When the polishing of the substrate W is terminated, the head arm 28 rotates 180 degrees, so that the polishing head 25 moves to the position above the substrate loader 33 together with the polished substrate W. The polishing head 25 releases the substrate W, and the substrate W is placed on the substrate loader 33. The holding hand 40 of the processing transporter 5 removes the substrate W from the substrate loader 33 and transports the substrate W into one of the plurality of cleaning modules 7 to 10. In this embodiment, since the CMP module 1A has two polishing heads 25, 25, while one polishing head 25 is located above the polishing pad 20 or polishing the substrate W, the other polishing head 25 can release the substrate W and can hold a substrate to be polished next.

The plurality of cleaning modules 7, 8, 9, 10 of this embodiment include the cleaning module 7 used as a pre-cleaning module or a post-cleaning module, and the plurality of (three in FIG. 1) cleaning modules 8, 9, 10 used as post-cleaning modules. The pre-cleaning module is a cleaning device for cleaning the substrate W before being polished by the CMP modules 1A, 1B. The post-cleaning module is a cleaning device for cleaning the substrate W after being polished by the CMP modules 1A, 1B. The cleaning module 7 and the cleaning module 8 are arranged along a vertical direction, and the cleaning module 9, the cleaning module 10, and the drying module 11 are also arranged along a vertical direction. A group of the cleaning modules 7, 8 is arranged apart from a group of the cleaning modules 9, 10 and the drying module 11. The cleaning module 7 is arranged above the cleaning module 8. The drying module 11 is arranged above the cleaning module 10, and the cleaning module 10 is arranged above the cleaning module 9.

The types of the four cleaning modules 7, 8, 9, and 10 are not particularly limited. In one example, the cleaning module 7 is a buff cleaning device or a sponge scrubbing device, the cleaning modules 8, 9 are sponge scrubbing devices, and the cleaning module 10 is a two-fluid jet cleaning device. The cleaning mechanism of the cleaning modules 7, 8, 9, and 10 can use a known configuration. The type of drying module 11 is also not particularly limited. For example, the drying module 11 may be an IPA drying device that dries the substrate W by spraying isopropyl alcohol vapor onto the substrate W, or may be a spin drying device that removes liquid from the substrate W by rotating the substrate W at high speed.

The operation of the processing transporter 5 can be switched between a pre-cleaning mode in which the substrate W is transported to the cleaning module 7 before being transported to the CMP module 1A or 1B, and a post-cleaning mode in which the substrate W is transported to the cleaning module 7 after being removed from the CMP module 1A or 1B. In the pre-cleaning mode, the cleaning module 7 operates as a pre-cleaning module. Specifically, the operation controller 15 instructs the processing transporter 5 to transport the substrate W from the substrate transporter 14 to the cleaning module 7 before transporting the substrate W to the CMP module 1A or 1B. The cleaning module 7 as the pre-cleaning module cleans the substrate W before polishing of the substrate W. In the post-cleaning mode, the cleaning module 7 operates as a post-cleaning module. Specifically, the operation controller 15 instructs the processing transporter 5 to transport the polished substrate W from the CMP module 1A or 1B to the cleaning module 7. The cleaning module 7 as the post-cleaning module cleans the polished substrate W.

In the pre-cleaning mode, the polished substrate W is transported in an order of the cleaning module 8, the cleaning module 9, and the cleaning module 10, and is cleaned by these cleaning modules 8, 9, and 10. In the post-cleaning mode, the polished substrate W is transported in an order of the cleaning module 7, the cleaning module 8, the cleaning module 9, and the cleaning module 10, and is cleaned by these cleaning modules 7, 8, 9, and 10.

In the present embodiment, the processing transporter 5 is configured to be accessible to the cleaning modules 7, 8, 9, and 10, and the relay transporter 6 is configured to be accessible to the cleaning module 10 and the drying module 11. Therefore, the processing transporter 5 transports the polished substrate W with a low cleanliness (i.e., the polishing liquid and polishing debris are attached to the substrate W), and the relay transporter 6 transports the cleaned substrate W with a high cleanliness. Furthermore, using these two transporters, i.e. the processing transporter 5 and the relay transporter 6, can make it possible to prevent transporting of the substrate from becoming a rate-limiting factor and can make it possible to process a plurality of substrates successively.

In one embodiment, the processing transporter 5 may have two holding hands 40 that are arranged one above another and operate independently of each other. In one embodiment, the relay transporter 6 may have two holding hands 60 that are arranged one above another and operate independently of each other. For example, the lower holding hand 40 can transport a wet substrate, and the upper holding hand 40 can transport a dry substrate. Similarly, the lower holding hand 60 can transport a wet substrate, and the upper holding hand 60 can transport a dry substrate.

In one embodiment, the processing transporter 5 may be configured to be able to access all of the cleaning modules 7, 8, 9, 10 and the drying module 11. In this case, the loading and unloading of the substrate W into and out of the cleaning modules 7, 8, 9, 10 and the drying module 11 is performed by the processing transporter 5.

The substrate transporter 14 includes a substrate stage 71 configured to support the substrate W, and a stage moving mechanism 72 configured to horizontally move the substrate stage 71. The substrate stage 71 is coupled to the stage moving mechanism 72. The stage moving mechanism 72 extends horizontally from one side to opposite side of the first processing unit 101. More specifically, the stage moving mechanism 72 extends in a width direction of the first processing unit 101 and is arranged above the cleaning modules 7, 8, 9, 10 and the drying module 11. The substrate transporter 14 of this embodiment is a linear transporter that moves the substrate W in a straight line.

The stage moving mechanism 72 is configured to stop the substrate stage 71 at a first position P1, a second position P2, and a third position P3. The first position P1 is located at one side of the first processing unit 101, and the second position P2 is located at the opposite side of the first processing unit 101. The third position P3 is located between the first position P1 and the second position P2. More specifically, the first position P1 is above the cleaning modules 7, 8, and the second position P2 is above the cleaning modules 9, 10 and the drying module 11. The third position P3 is located between the group of cleaning modules 7, 8 and the group of cleaning modules 9, 10 and drying module 11.

The substrate processing apparatus includes a load-unload section 50 adjacent to the first processing unit 101. As shown in FIGS. 2 and 3, the load-unload section 50 includes a cassette loader 53 on which a cassette storage 100 containing a plurality of substrates W is placed, and a transfer robot 55 configured to remove one substrate W to be polished from the cassette storage 100 and transport the substrate to the substrate transporter 14. The transfer robot 55 is arranged between the cassette loader 53 and the substrate transporter 14.

The substrate processing apparatus further includes a horizontal movement mechanism 56 and a vertical movement mechanism 57 configured to move the transfer robot 55 horizontally and vertically. The transfer robot 55, the horizontal movement mechanism 56, and the vertical movement mechanism 57 are coupled to the operation controller 15 shown in FIG. 1 so that operations of the transfer robot 55, the horizontal movement mechanism 56, and the vertical movement mechanism 57 are controlled by the operation controller 15.

The vertical movement mechanism 57 is configured to move the transfer robot 55 up and down between the cassette storage 100 and the substrate transporter 14. Specifically, the transfer robot 55 removes one substrate W to be polished from the cassette storage 100, moves up to the substrate transporter 14 by the vertical movement mechanism 57, and places the substrate W onto the substrate stage 71 of the substrate transporter 14 of the first processing unit 101. Furthermore, the substrate W that has been processed (polished, cleaned, dried) by at least one of the first processing unit 101 and the second processing unit 102 is removed from the substrate stage 71 of the substrate transporter 14 of the first processing unit 101 by the transfer robot 55. The transfer robot 55 is lowered together with the processed substrate W by the vertical movement mechanism 57, and returns the processed substrate W to the cassette storage 100.

The polishing heads 25, 25 are suspended from a frame (not shown). More specifically, the support shaft 29 extends downward from the frame (not shown), and the head arm 28 is rotatably supported by a lower part of the support shaft 29. The arm rotation motor (not shown) configured to rotate the head arm 28 and the two polishing heads 25, 25 around the support shaft 29 is installed on the head arm 28 or the support shaft 29. The CMP module 1B also has the same configuration.

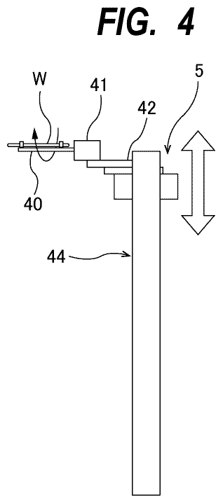

FIG. 4 is a diagram illustrating an embodiment of the processing transporter 5. As shown in FIG. 4, the processing transporter 5 includes the holding hand 40 configured to hold the substrate W, an inverting device 41 configured to invert the holding hand 40, a robot arm 42 to which the inverting device 41 is fixed, and an elevating mechanism 44 configured to elevate and lower the holding hand 40, the inverting device 41, and the robot arm 42.

The holding hand 40 is configured to hold a peripheral edge of the substrate W such that the substrate W does not fall from the holding hand 40 when the substrate W and the holding hand 40 are inverted by the inverting device 41. The inverting device 41 is configured to rotate the holding hand 40 holding the substrate W around a horizontal axis until the substrate W is inverted.

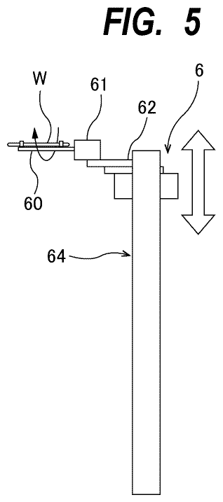

FIG. 5 is a diagram illustrating one embodiment of the relay transporter 6. The relay transporter 6 has basically the same configuration as the processing transporter 5. Specifically, as shown in FIG. 5, the relay transporter 6 includes a holding hand 60 configured to hold the substrate W, an inverting device 61 configured to invert the holding hand 60, a robot arm 62 to which the inverting device 61 is fixed, and an elevating mechanism 64 configured to elevate and lower the holding hand 60, the inverting device 61, and the robot arm 62.

The holding hand 60 is configured to hold the peripheral edge of the substrate W such that the substrate W does not fall from the holding hand 60 when the substrate W and the holding hand 60 are inverted by the inverting device 61. The inverting device 61 is configured to rotate the holding hand 60 holding the substrate W around a horizontal axis until the substrate W is inverted.

As shown in FIGS. 1 to 3, the processing transporter 5 is configured to be able to access the substrate stage 71 located at the third position P3 of the substrate transporter 14. The substrate W before polishing is transported by the substrate transporter 14 with the surface to be polished facing upward, and is stopped at the third position P3, as shown in FIG. 2. The holding hand 40 ascends to the substrate transporter 14 and removes the substrate from the substrate stage 71 located at the third position P3.

In the pre-cleaning mode described above, the processing transporter 5 carries the substrate W to be polished into the cleaning module 7 with the surface to be polished facing upward. The substrate W is pre-cleaned by the cleaning module 7. The processing transporter 5 removes the pre-cleaned substrate W from the cleaning module 7, and then the inverting device 41 of the processing transporter 5 inverts the substrate W until the surface to be polished of the substrate W faces downward. Further, the processing transporter 5 places the substrate W onto the substrate loader 33 of either the CMP module 1A or 1B.

In the above-mentioned post-cleaning mode, the processing transporter 5 removes the substrate W before polishing from the substrate transporter 14, and then the inverting device 41 of the processing transporter 5 inverts the substrate W until the surface to be polished of the substrate W faces downward. Further, the processing transporter 5 places the substrate W onto the substrate loader 33 of either the CMP module 1A or 1B.

In both the pre-cleaning mode and the post-cleaning mode, the substrate W is inverted after the substrate W is removed from the substrate transporter 14 and before the substrate W is carried into either the CMP module 1A or 1B. The substrate W may be inverted before the substrate W is lowered, or when the substrate W is being lowered, or after the substrate W is lowered.

The substrate W that has been polished by either the CMP module 1A or 1B is released from the polishing head 25 onto the substrate loader 33 with the polished surface facing downward. The holding hand 40 of the processing transporter 5 removes the polished substrate W from the substrate loader 33. Thereafter, the inverting device 41 of the processing transporter 5 inverts the holding hand 40 and the substrate W such that the polished surface faces upward. Then, the substrate W is carried into the cleaning module 7 or 8.

In this way, the processing transporter 5 can perform a series of operations including removing the substrate W from the CMP module, inverting the substrate W, and carrying the substrate W into the cleaning module. As a result, a time required for transporting the polished substrate W from the CMP module to the cleaning module can be shortened. In particular, since the polished substrate is directly carried into the cleaning module by the processing transporter 5 (i.e., without passing through a temporary station or the like), the time required to transport the polished substrate W can be shortened. As a result, corrosion of a metal on the surface of the substrate W can be prevented as much as possible. Furthermore, a plurality of substrates polished by the CMP modules 1A and 1B can be transported to the drying module via one or more cleaning modules with the same transportation time.

The polished substrate W is cleaned by at least one of the plurality of cleaning modules 7, 8, 9, and 10. In one example, the polished substrate W is transported by the processing transporter 5 in the order of the cleaning module 8, the cleaning module 9, and the cleaning module 10, and is cleaned by these cleaning modules 8, 9, and 10. The cleaned substrate W is transported from the cleaning module 10 to the drying module 11 by the relay transporter 6, and is dried by the drying module 11. The substrate W that has been processed in this manner (i.e., polished, cleaned, and dried) is transported onto the substrate stage 71 at the second position P2 of the substrate transporter 14 of the first processing unit 101 by the relay transporter 6 of the first processing unit 101. The substrate transporter 14 transports the substrate W from the second position P2 to the first position P1. The transfer robot 55 removes the substrate W from the substrate transporter 14 and returns the substrate W to the cassette storage 100.

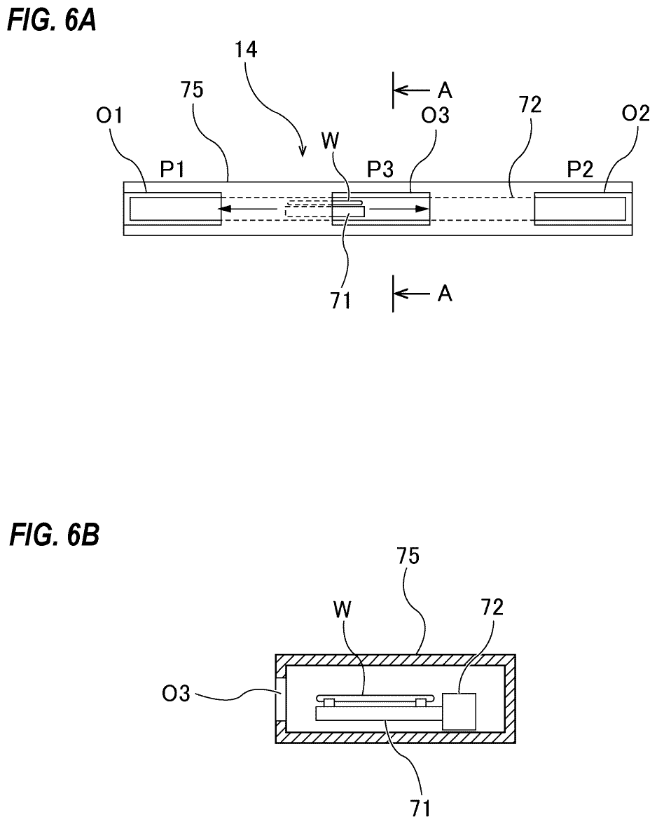

FIG. 6A is a side view showing an embodiment of the substrate transporter 14, and FIG. 6B is a cross-sectional view taken along line A-A in FIG. 6A. The substrate transporter 14 of the embodiment shown in FIGS. 6A and 6B includes a tunnel cover 75 that covers entireties of the substrate stage 71 and the stage moving mechanism 72. The tunnel cover 75 extends from the first position P1 to the second position P2 along a longitudinal direction of the stage moving mechanism 72. The substrate stage 71 is movable inside the tunnel cover 75. Since the tunnel cover 75 always covers the substrate W on the moving substrate stage 71, the substrate W can be protected from foreign substances, such as particles, and the cleanliness of the substrate W can be maintained.

The tunnel cover 75 has a first opening O1 at the first position P1, a second opening O2 at the second position P2, and a third opening O3 at the third position P3. A shutter (not shown) is provided at each of the first opening O1, the second opening O2, and the third opening O3. The processing transporter 5 can remove the substrate W from the substrate stage 71 through the third opening O3. The relay transporter 6 can transport the substrate W to the substrate stage 71 through the second opening O2 and can remove the substrate W from the substrate stage 71 through the second opening O2. The transfer robot 55 can transport the substrate W to the substrate stage 71 through the first opening O1 of the first processing unit 101 and can remove the substrate W from the substrate stage 71 through the first opening O1 of the first processing unit 101. The relay transporter 6 can transport the substrate W to the substrate stage 71 through the first opening O1 of the substrate transporter 14 of the second processing unit 102, and can remove the substrate W from the substrate stage 71 through the first opening O1 of the substrate transporter 14 of the second processing unit 102. The first opening O1 of the first processing unit 101 and the first opening O1 of the second processing unit 102 may be provided at different positions or angles with respect to the substrate stage 71 located at the first position P1.

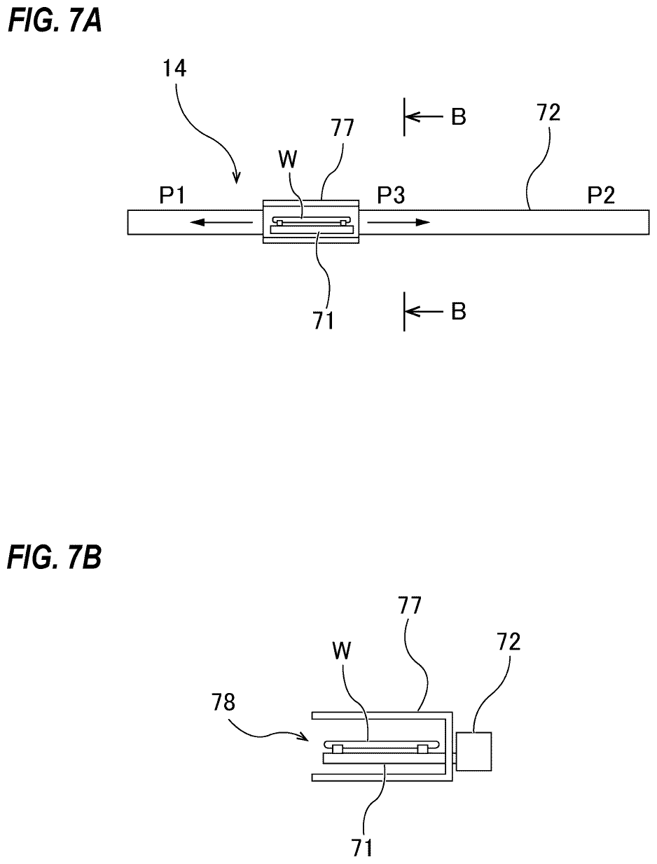

FIG. 7A is a side view showing another embodiment of the substrate transporter 14, and FIG. 7B is a cross-sectional view taken along line B-B in FIG. 7A. The substrate transporter 14 shown in FIGS. 7A and 7B includes a stage cover 77 that covers the entire substrate stage 71. The stage cover 77 is fixed to the substrate stage 71 and is movable together with the substrate stage 71. Since the stage cover 77 always covers the substrate W on the moving substrate stage 71, the substrate W can be protected from foreign substances, such as particles, and the cleanliness of the substrate W can be maintained.

The substrate W is transported into and out of the substrate transporter 14 at each of the first position P1, second position P2, and third position P3 through an opening 78 of the stage cover 77. The stage cover 77 may have a wall on a moving direction side. A shutter may be provided at the opening 78 of the stage cover 77. The tunnel cover 75 in FIG. 6 and the stage cover 77 in FIG. 7 may be combined.

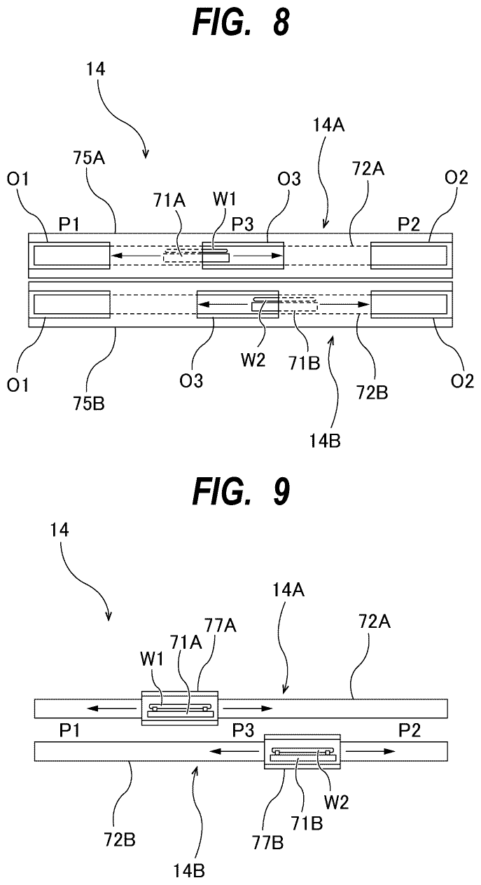

FIG. 8 is a side view showing still another embodiment of the substrate transporter 14. The substrate transporter 14 shown in FIG. 8 includes two sets of substrate transporters 14 shown in FIGS. 6A and 6B. Specifically, the substrate transporter 14 shown in FIG. 8 includes an upper substrate transporter 14A and a lower substrate transporter 14B. The upper substrate transporter 14A is arranged over the lower substrate transporter 14B.

The upper substrate transporter 14A includes an upper substrate stage 71A configured to support a substrate W1, an upper stage moving mechanism 72A configured to horizontally move the upper substrate stage 71A, and an upper tunnel cover 75A that covers entireties of the upper substrate stage 71A and the upper stage moving mechanism 72A. The upper substrate stage 71A is coupled to the upper stage moving mechanism 72A.

The lower substrate transporter 14B includes a lower substrate stage 71B configured to support a substrate W2, a lower stage moving mechanism 72B configured to horizontally move the lower substrate stage 71B, and a lower tunnel cover 75B that covers entireties of the lower substrate stage 71B and the lower stage moving mechanism 72B. The lower substrate stage 71B is coupled to the lower stage moving mechanism 72B.

The upper substrate stage 71A, the upper stage moving mechanism 72A, and the upper tunnel cover 75A are arranged over the lower substrate stage 71B, the lower stage moving mechanism 72B, and the lower tunnel cover 75B. The upper stage moving mechanism 72A and the lower stage moving mechanism 72B can independently move the upper substrate stage 71A and the lower substrate stage 71B. Therefore, for example, the substrate transporter 14 can transport the substrate W1 to the first processing unit 101 while transporting the substrate W2 to the second processing unit 102. As a result, a throughput of substrate processing can be improved.

FIG. 9 is a side view showing still another embodiment of the substrate transporter 14. The substrate transporter 14 shown in FIG. 9 has two sets of substrate transporters 14 shown in FIGS. 7A and 7B. Specifically, the substrate transporter 14 shown in FIG. 9 includes an upper substrate transporter 14A and a lower substrate transporter 14B. The upper substrate transporter 14A is arranged over the lower substrate transporter 14B.

The upper substrate transporter 14A includes an upper substrate stage 71A configured to support a substrate W1, an upper stage moving mechanism 72A configured to horizontally move the upper substrate stage 71A, and an upper stage cover 77A that covers the entire upper substrate stage 71A. The lower substrate transporter 14B includes a lower substrate stage 71B configured to support a substrate W2, a lower stage moving mechanism 72B configured to horizontally move the lower substrate stage 71B, and a lower stage cover 77B that covers the entire lower substrate stage 71B.

The upper substrate stage 71A, the upper stage moving mechanism 72A, and the upper stage cover 77A are arranged over the lower substrate stage 71B, the lower stage moving mechanism 72B, and the lower stage cover 77B. The upper stage moving mechanism 72A and the lower stage moving mechanism 72B can independently move the upper substrate stage 71A and the lower substrate stage 71B. Therefore, for example, the substrate transporter 14 can transport the substrate W1 to the first processing unit 101 while transporting the substrate W2 to the second processing unit 102. As a result, a throughput of substrate processing can be improved.

In the embodiment shown in FIG. 8 or 9, the upper substrate transporter 14A may be used for a dedicated transportation route for returning the substrate W to the load-unload section 50 after substrate processing (polishing, cleaning, drying). The substrate W that has been dried by the drying module 11 of the first processing unit 101 is removed from the drying module 11 by the relay transporter 6, placed on the upper substrate stage 71A of the upper substrate transporter 14A, and transported to the load-unload section 50. In this way, the upper substrate transporter 14A and the lower substrate transporter 14B may be used for a transportation route for transporting a substrate W that has been processed and a transportation route for transporting a substrate W to be processed. As a result, a throughput of substrate processing can be improved.

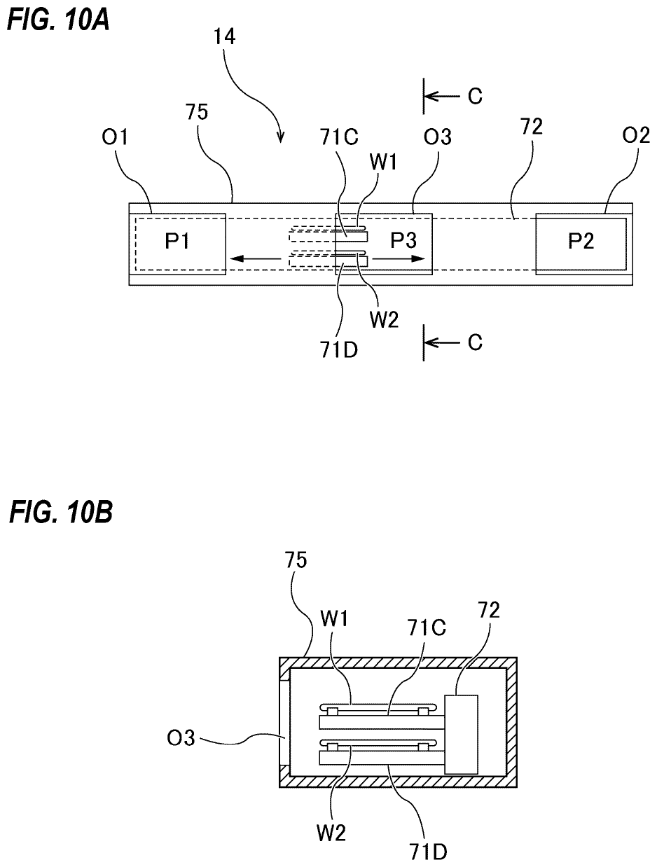

FIG. 10A is a side view showing still another embodiment of the substrate transporter 14, and FIG. 10B is a cross-sectional view taken along line C-C in FIG. 10A. The substrate transporter 14 shown in FIGS. 10A and 10B includes an upper substrate stage 71C and a lower substrate stage 71D arranged along the vertical direction, a stage moving mechanism 72 configured to horizontally move the upper substrate stage 71C and the lower substrate stage 71D, and a tunnel cover 75 that covers the entireties of the upper substrate stage 71C, the lower substrate stage 71D, and the stage moving mechanism 72.

The upper substrate stage 71C and the lower substrate stage 71D are coupled to the stage moving mechanism 72, so that the upper substrate stage 71C and the lower substrate stage 71D are moved together by the stage moving mechanism 72. The tunnel cover 75 has a first opening O1 at the first position P1, a second opening O2 at the second position P2, and a third opening O3 at the third position P3. The tunnel cover 75 extends from the first position P1 to the second position P2 along a longitudinal direction of the stage moving mechanism 72. The upper substrate stage 71C and the lower substrate stage 71D are movable inside the tunnel cover 75.

The upper substrate stage 71C and the lower substrate stage 71D can simultaneously transport substrates W1 and W2. Therefore, for example, after the substrate W1 is removed from the upper substrate stage 71C at the third position P3 by the processing transporter 5 of the first processing unit 101, the lower substrate stage 71D transports the substrate W2 to the second position P2, and the relay transporter 6 of the second processing unit 102 can remove the substrate W2 from the lower substrate stage 71D. As a result, a throughput of substrate processing can be improved. In this embodiment, the transfer robot 55 (see FIG. 2) of the load-unload section 50 is desirably configured to transport two substrates simultaneously.

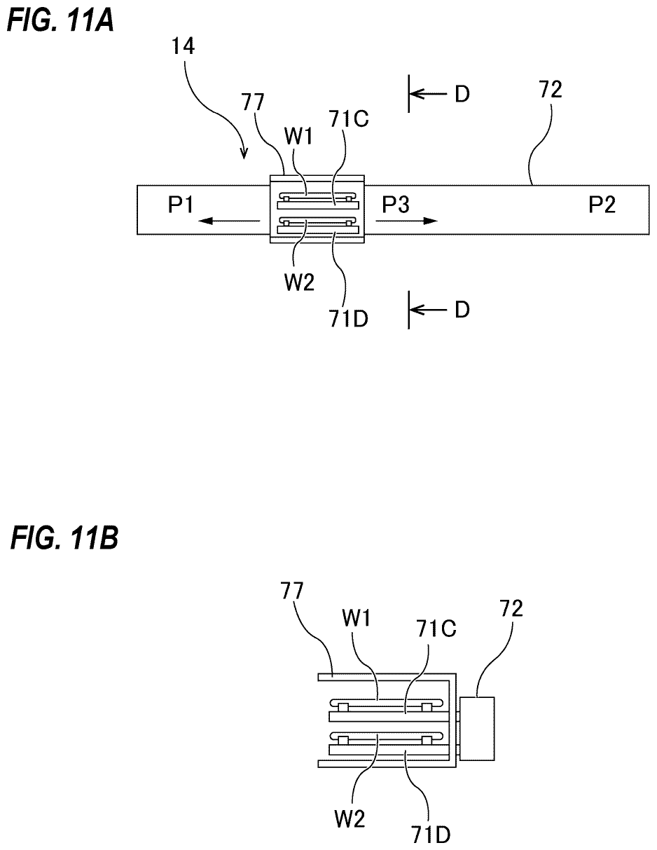

FIG. 11A is a side view showing still another embodiment of the substrate transporter 14, and FIG. 11B is a cross-sectional view taken along line D-D in FIG. 11A. The substrate transporter 14 shown in FIGS. 11A and 11B includes an upper substrate stage 71C and a lower substrate stage 71D arranged along the vertical direction, a stage moving mechanism 72 configured to horizontally move the upper substrate stage 71C and the lower substrate stage 71D, and a stage cover 77 that covers entireties of the upper substrate stage 71C and the lower substrate stage 71D.

The upper substrate stage 71C and the lower substrate stage 71D are coupled to the stage moving mechanism 72. The stage cover 77 is fixed to at least one of the upper substrate stage 71C and the lower substrate stage 71D. The upper substrate stage 71C, the lower substrate stage 71D, and the stage cover 77 are moved together by the stage moving mechanism 72.

The upper substrate stage 71C and the lower substrate stage 71D can simultaneously transport substrates W1 and W2. Therefore, for example, after the substrate W1 is removed from the upper substrate stage 71C at the third position P3 by the processing transporter 5 of the first processing unit 101, the lower substrate stage 71D can transport the substrate W2 to the second position P2, and the relay transporter 6 of the second processing unit 102 can remove the substrate W2 from the lower substrate stage 71D. As a result, a throughput of substrate processing can be improved. In this embodiment, it is preferable that the transfer robot 55 (see FIG. 2) of the load-unload section 50 is configured to transport two substrates simultaneously.

Next, details of the second processing unit 102 will be described. The second processing unit 102 includes the partial polishing modules 1C and 1D configured to polish a portion of the surface of the substrate W, a plurality of cleaning modules 7, 8, 9, and 10 configured to clean the substrate W, a drying module 11 configured to dry the cleaned substrate W, a substrate transporter 14 that extends from one side to opposite side of the second processing unit 102, and a processing transporter 5 configured to transport the substrate W from the substrate transporter 14 to the partial polishing modules 1C and 1D, and from the partial polishing modules 1C and 1D to the plurality of cleaning modules 7, 8, and 9. The processing transporter 5 is configured to transport the substrate W among the cleaning modules 7, 8, 9, and 10. The second processing unit 102 further includes a relay transporter 6 configured to transport the substrate W from the cleaning module 10 to the drying module 11, and from the drying module 11 to the substrate transporter 14.

As described above, configurations of the cleaning modules 7, 8, 9, and 10, the processing transporter 5, and the relay transporter 6 of the second processing unit 102, as well as other configurations of the second processing unit 102 that will not be specifically described, are the same as those of the first processing unit 101. Therefore, the descriptions of the configurations with reference to FIGS. 1 to 11 apply to the second processing unit 102 as well. Accordingly, redundant description of the second processing unit 102 is omitted.

The second processing unit 102 includes the partial polishing modules 1C and 1D as surface-processing modules in place of the CMP modules 1A and 1B. Since the partial polishing modules 1C and 1D have the same configuration, the partial polishing module 1C will be described below.

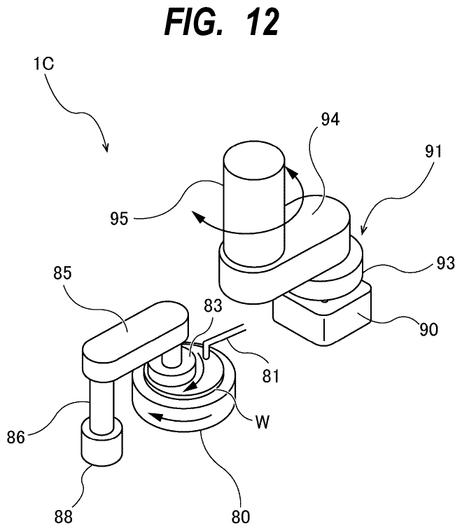

FIG. 12 is a perspective view showing one embodiment of the partial polishing module 1C. As shown in FIG. 12, the partial polishing module 1C includes a rotational table 80 configured to hold and rotate the substrate W, a polishing-liquid supply nozzle 81 configured to supply a polishing liquid onto the surface of the substrate W, a polishing head 83 configured to come into sliding contact with a portion of the surface of the substrate W and locally polish the surface of the substrate W, and a head arm 85 that rotatably supports the polishing head 83. The polishing head 83 has a diameter smaller than that of the substrate W. A lower surface of the polishing head 83 constitutes a polishing surface for polishing the surface of the substrate W. The polishing surface is formed of, for example, a buff pad.

A polishing-head rotating device (not shown) configured to rotate the polishing head 83 about its axis, and a polishing-head pressing device (not shown) configured to press the polishing head 83 against the surface of the substrate W are disposed in the head arm 85. The partial polishing module 1C includes a support shaft 86 that supports the head arm 85 and an arm rotating device 88 configured to rotate the head arm 85 about the support shaft 86. The arm rotating device 88 is configured to move the polishing head 83 between a position above the rotational table 80 and a retracted position outside the rotational table 80 by rotating the support shaft 86 and the head arm 85 by a predetermined angle. In one embodiment, the arm rotating device 88 may be disposed in the support shaft 86 or in the head arm 85.

The partial polishing module 1C further includes a substrate placement stage 90 on which the substrate W, transferred by the processing transporter 5, is placed, and a substrate conveyor 91 configured to transport the substrate W between the substrate placement stage 90 and the rotational table 80. The substrate placement stage 90 is arranged outwardly of the rotational table 80. The processing transporter 5 (see FIGS. 1 to 3) places the substrate W onto the substrate placement stage 90 with the surface to be polished facing upward.

The substrate conveyor 91 includes a transfer hand 93 configured to transport the substrate W, a transfer arm 94 that holds the transfer hand 93, an arm shaft 95 coupled to the transfer arm 94, and an arm swing motor (not shown) configured to rotate the transfer hand 93 about the arm shaft 95. This arm swing motor is installed in the transfer arm 94 or the arm shaft 95. The transfer hand 93 is schematically illustrated. The transfer hand 93 is configured to hold the substrate W on the substrate placement stage 90. When the transfer arm 94 is rotated by a predetermined angle by the arm swing motor (not shown), the transfer hand 93 holding the substrate W is moved to a position above the rotational table 80. The substrate W is then placed on the rotational table 80. The substrate W is held on the upper surface of the rotational table 80 by vacuum suction.

Partial polishing of the substrate W is performed as follows. While the substrate W rotates together with the rotational table 80, the polishing liquid is supplied onto the substrate W from the polishing-liquid supply nozzle 81. The polishing head 83 is pressed against a portion of the surface of the substrate W by the polishing-head pressing device (not shown) while the polishing head 83 is rotated by the polishing-head rotating device (not shown) disposed in the head arm 85. A portion of the surface of the substrate W is polished by the polishing head 83 in the presence of the polishing liquid. The partial polishing modules 1C and 1D are used to alter or adjust a film thickness profile of the substrate W by locally or selectively polishing only a portion of the surface of the substrate W where a film thickness is large.

When polishing of the substrate W is completed, the transfer hand 93 holds the substrate W on the rotational table 80 and moves, together with the substrate W, to a position above the substrate placement stage 90. The transfer hand 93 releases the substrate W, so that the substrate W is placed on the substrate placement stage 90. The holding hand 40 of the processing transporter 5 shown in FIGS. 1 to 3 removes the substrate W from the substrate placement stage 90 and carries the substrate W into any one of the plurality of cleaning modules 8 to 10.

The cleaning and drying of the substrate W, the pre-cleaning mode, and the post-cleaning mode described with respect to the first processing unit 101 are performed in the second processing unit 102 as well. The cleaning module 7 may be used for pre-cleaning or post-cleaning of the substrate W.

As shown in FIG. 3, when viewed from above the processing transporter 5, the two CMP modules 1A and 1B (more specifically, the substrate loaders 33 of the CMP modules 1A and 1B) are located at the same distance from the processing transporter 5 of the first processing unit 101 (more specifically, from a home position of the holding hand 40). Therefore, the processing transporter 5 can transport a plurality of substrates polished by the two CMP modules 1A and 1B to the same cleaning module (for example, the cleaning module 8) in substantially the same transport time. Furthermore, the plurality of substrates polished by the two CMP modules 1A and 1B are transported to the cleaning modules and the drying modules in a common path. Accordingly, the plurality of substrates polished by the CMP modules 1A and 1B can be cleaned and dried within substantially the same time.

Similarly, as shown in FIG. 3, when viewed from above the processing transporter 5, the two partial polishing modules 1C and 1D (more specifically, the substrate placement stages 90 of the partial polishing modules 1C and 1D) are located at the same distance from the processing transporter 5 of the second processing unit 102 (more specifically, from the home position of the holding hand 40). Therefore, the processing transporter 5 can transport a plurality of substrates polished by the two partial polishing modules 1C and 1D to the same cleaning module (for example, the cleaning module 8) in substantially the same transport time.

When viewed from above the processing transporter 5, distances from the plurality of surface-processing modules (i.e., the CMP modules, the partial polishing modules) of each of the first processing unit 101 and the second processing unit 102 to the processing transporter 5 of each processing unit are the same. Specifically, when viewed from above the processing transporter 5, the distances from the CMP modules 1A, 1B of the first processing unit 101 to the processing transporter 5 of the first processing unit 101 are the same as the distances of the partial polishing modules 1C, 1D of the second processing unit 102 to the processing transporter 5 of the second processing unit 102.

In addition, when viewed from above the processing transporter 5, distances from the plurality of cleaning modules of each of the first processing unit 101 and the second processing unit 102 to the processing transporter 5 of each processing unit are the same. Specifically, when viewed from above the processing transporter 5, the distances from the cleaning modules 7, 8, 9, 10 of the first processing unit 101 to the processing transporter 5 of the first processing unit 101 are the same as the distances from the cleaning modules 7, 8, 9, 10 of the second processing unit 102 to the processing transporter 5 of the second processing unit 102. Therefore, a plurality of substrates polished by the plurality of surface-processing modules (i.e., the CMP modules, the partial polishing modules) of the first processing unit 101 and the second processing unit 102 can be transported to the cleaning module in substantially the same transport time.

As shown in FIG. 3, the relay transporter 6 of the first processing unit 101 is arranged between the first processing unit 101 and the second processing unit 102. The two CMP modules 1A and 1B of the first processing unit 101 and the two partial polishing modules 1C and 1D of the second processing unit 102 are arranged along a horizontal direction at equal intervals. Similarly, the processing transporter 5 and the relay transporter 6 of the first processing unit 101 and the processing transporter 5 and the relay transporter 6 of the second processing unit 102 are arranged at equal intervals. Arrangement intervals of the CMP modules 1A, 1B and the partial polishing modules 1C, 1D of the first processing unit 101 and the second processing unit 102 are the same as arrangement intervals of the two processing transporters 5 and the two relay transporters 6 of the first processing unit 101 and the second processing unit 102. As shown in FIG. 3, the processing transporter 5 of the first processing unit 101 is located at the same distance from the CMP modules 1A and 1B, and the relay transporter 6 of the first processing unit 101 is located at the same distance from the CMP module 1B and the partial polishing module 1C.

The second position P2 of the substrate transporter 14 of the first processing unit 101 is adjacent to the first position P1 of the substrate transporter 14 of the second processing unit 102. The relay transporter 6 of the first processing unit 101 is configured to be accessible to both the second position P2 of the substrate transporter 14 of the first processing unit 101 and the first position P1 of the substrate transporter 14 of the second processing unit 102. Therefore, the relay transporter 6 of the first processing unit 101 can remove the substrate W from the substrate stage 71 located at the second position P2 of the substrate transporter 14 of the first processing unit 101 and place the substrate W onto the substrate stage 71 located at the first position P1 of the substrate transporter 14 of the second processing unit 102. For example, a first substrate can be processed in the first processing unit 101, while a second substrate can be transported to the second processing unit 102 via the substrate transporter 14 and the relay transporter 6 of the first processing unit 101, so that the second substrate can be processed in the second processing unit 102.

The relay transporter 6 of the first processing unit 101 is configured to be accessible to the CMP module 1B, the cleaning module 10, and the drying module 11 of the first processing unit 101, and the partial polishing module 1C and the cleaning modules 7, 8 of the second processing unit 102. As shown in FIG. 3, when viewed from above the relay transporter 6 of the first processing unit 101, a distance from the relay transporter 6 of the first processing unit 101 to the CMP module 1B of the first processing unit 101 is the same as a distance from the relay transporter 6 of the first processing unit 101 to the partial polishing module 1C of the second processing unit 102. Furthermore, when viewed from above the relay transporter 6 of the first processing unit 101, a distance from the relay transporter 6 of the first processing unit 101 to the cleaning module 10 and the drying module 11 of the first processing unit 101 is the same as a distance from the relay transporter 6 of the first processing unit 101 to the cleaning modules 7 and 8 of the second processing unit 102.

In one example, the relay transporter 6 of the first processing unit 101 removes the substrate W from the substrate loader 33 of the CMP module 1B of the first processing unit 101, and can directly transport the substrate W to the substrate placement stage 90 of the partial polishing module 1C of the second processing unit 102. Therefore, the substrate processing apparatus can polish the substrate W by at least one of the two CMP modules 1A and 1B of the first processing unit 101, and then the relay transporter 6 of the first processing unit 101 can directly transport the substrate W from the CMP module 1B of the first processing unit 101 to the partial polishing module 1C of the second processing unit 102 without passing through the substrate transporter 14, so that at least one of the two partial polishing modules 1C, 1D of the second processing unit 102 can further polish the substrate W.

In another example, the relay transporter 6 of the first processing unit 101 removes the substrate W from the substrate loader 33 of the CMP module 1B of the first processing unit 101, and can directly transport the substrate W to either one of the cleaning modules 7, 8 of the second processing unit 102. Such a transportation route is adopted when any one of the cleaning modules 7, 8, 9, 10 and the drying module 11 of the first processing unit 101 is out of order.

In yet another example, the relay transporter 6 of the first processing unit 101 removes the substrate W from the substrate placement stage 90 of the partial polishing module 1C of the second processing unit 102, and can directly transport the substrate W to the substrate loader 33 of the CMP module 1B of the first processing unit 101. Therefore, the substrate processing apparatus can polish the substrate W by at least one of the two partial polishing modules 1C and 1D of the second processing unit 102, and then the relay transporter 6 of the first processing unit 101 can transport the substrate W from the partial polishing module 1C of the second processing unit 102 to the CMP module 1B of the first processing unit 101 without passing through the substrate transporter 14, so that at least one of the two CMP modules 1A and 1B of the first processing unit 101 can further polish the substrate W.

As shown in FIG. 3, the processing transporter 5 and the relay transporter 6 of the first processing unit 101 and the processing transporter 5 and the relay transporter 6 of the second processing unit 102 are arranged alternately at equal intervals. Furthermore, the plurality of CMP modules 1A and 1B of the first processing unit 101 and the plurality of partial polishing modules 1C and 1D of the second processing unit 102 are also arranged at equal intervals. The arrangement intervals of the processing transporters 5 and the relay transporters 6 of the first processing unit 101 and the second processing unit 102 are the same as the arrangement intervals of the CMP modules 1A, 1B and the partial polishing modules 1C, 1D of the first processing unit 101 and the second processing unit 102.

With the above arrangements, the relay transporter 6 of the first processing unit 101 can directly transport the substrate W between the CMP module 1B of the first processing unit 101 and the partial polishing module 1C of the processing unit 102 without passing through the substrate transporter 14. Therefore, the substrate processing apparatus can polish the substrate W in multiple stages using two, three, or four of the CMP modules 1A, 1B and the partial polishing modules 1C, 1D. The substrate W that has been polished, cleaned, and dried in the second processing unit 102 is transported to the load-unload section 50 by the substrate transporter 14 of the second processing unit 102 and the relay transporter 6 and the substrate transporter 14 of the first processing unit 101.

The CMP modules 1A and 1B and the partial polishing modules 1C and 1D can be selectively used based on the purpose of polishing the substrate W. In one example, processing of the substrate W (polishing, cleaning, and drying) can be completed within the first processing unit 101. Specifically, the substrate W is polished by at least one of the CMP modules 1A and 1B of the first processing unit 101, and is then cleaned and dried by the cleaning modules 8, 9, and 10 and the drying module 11 of the first processing unit 101. In another example, processing of the substrate W (polishing, cleaning, and drying) can be completed within the second processing unit 102. Specifically, the substrate W is locally polished by at least one of the partial polishing modules 1C and 1D of the second processing unit 102, and is then cleaned and dried by the cleaning modules 8, 9, and 10 and the drying module 11 of the second processing unit 102. Processing of a substrate in the first processing unit 101 and processing of a substrate in the second processing unit 102 may be performed in parallel or alternately.

In yet another example, as described below, the substrate W may be polished by at least one of the CMP modules 1A and 1B and by at least one of the partial polishing modules 1C and 1D.

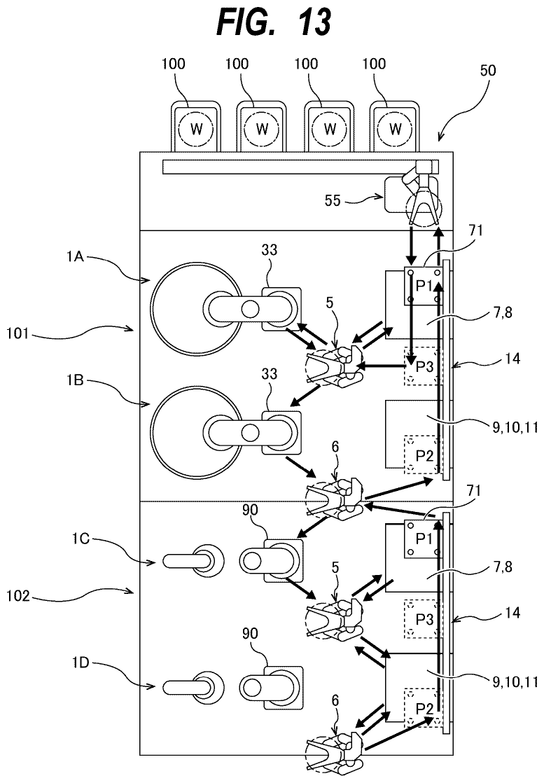

FIG. 13 is a diagram showing an example of a transportation route and a processing sequence for a substrate W. The substrate W is transported from the cassette storage 100 to the first position P1 of the substrate transporter 14 of the first processing unit 101 by the transfer robot 55. The substrate transporter 14 transports the substrate W from the first position P1 to the third position P3. In the first processing unit 101, the substrate W is transported by the processing transporter 5 in the order of the cleaning module (pre-cleaning module) 7, the CMP module 1A, and the CMP module 1B. The substrate W is pre-cleaned by the cleaning module 7 and is then polished by the CMP modules 1A and 1B.

The substrate W polished in the first processing unit 101 is transported from the CMP module 1B of the first processing unit 101 to the partial polishing module 1C of the second processing unit 102 by the relay transporter 6 of the first processing unit 101, and partial polishing (local polishing) of the substrate W is then performed by the partial polishing module 1C. Furthermore, the substrate W is transported by the processing transporter 5 of the second processing unit 102 to the cleaning modules 8, 9, and 10 of the second processing unit 102, so that the substrate W is cleaned by the cleaning modules 8, 9, and 10. The cleaned substrate W is transported by the relay transporter 6 of the second processing unit 102 to the drying module 11, so that the substrate W is dried by the drying module 11. The dried substrate W is transported by the relay transporter 6 of the second processing unit 102 to the second position P2 of the substrate transporter 14.

The substrate W that has been processed (polished, cleaned, and dried) by the first processing unit 101 and the second processing unit 102 is transported from the second position P2 to the first position P1 by the substrate transporter 14 of the second processing unit 102. Furthermore, the substrate W is transported from the first position P1 of the second processing unit 102 to the second position P2 of the first processing unit 101 by the relay transporter 6 of the first processing unit 101, and is further transported from the second position P2 to the first position P1 by the substrate transporter 14 of the first processing unit 101. The substrate W is then returned to the cassette storage 100 by the transfer robot 55.

In the example shown in FIG. 13, two-stage polishing of the substrate W is performed by the two CMP modules 1A and 1B, while, in another example, the substrate W may be polished by only one of the two CMP modules 1A and 1B. In yet another example, the substrate W may be polished by both of the partial polishing modules 1C and 1D. In one embodiment, the cleaning module 7 may be used as the post-cleaning module instead of the pre-cleaning module. In one embodiment, at least one of the four cleaning modules 7, 8, 9, and 10 may be used as the post-cleaning module.

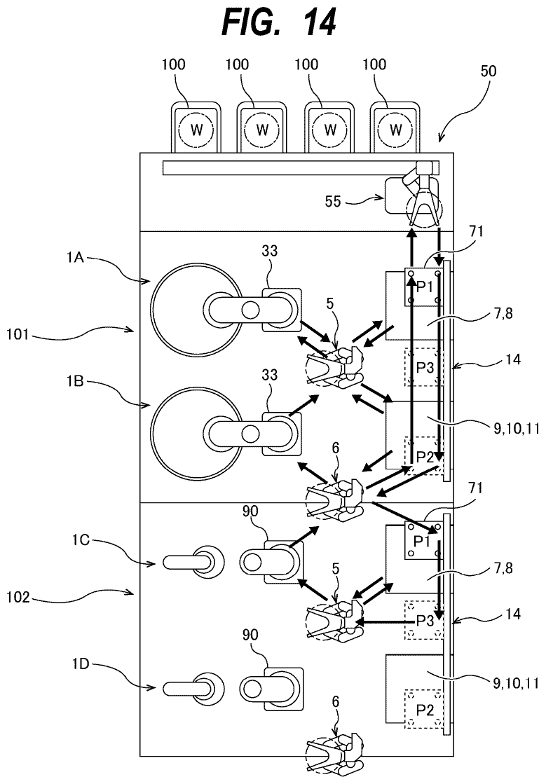

FIG. 14 is a diagram showing another example of the transportation route and the processing sequence for a substrate W. The substrate W is transported from the cassette storage 100 to the substrate transporter 14 of the first processing unit 101 by the transfer robot 55. The substrate W is transported from the first position P1 to the second position P2 by the substrate transporter 14. Further, the substrate W is transported from the second position P2 of the substrate transporter 14 of the first processing unit 101 to the first position P1 of the substrate transporter 14 of the second processing unit 102 by the relay transporter 6 of the first processing unit 101. The substrate transporter 14 of the second processing unit 102 transports the substrate W from the first position P1 to the third position P3. In the second processing unit 102, the substrate W is transported by the processing transporter 5 in the order of the cleaning module (pre-cleaning module) 7 and the partial polishing module 1C. The substrate W is pre-cleaned by the cleaning module 7 and is then polished by the partial polishing module 1C.

The substrate W polished in the second processing unit 102 is transported by the relay transporter 6 of the first processing unit 101 from the partial polishing module 1C to the CMP module 1B of the first processing unit 101, and the substrate W is polished by the CMP module 1B. Furthermore, the substrate W is transported from the CMP module 1B to the CMP module 1A by the processing transporter 5 of the first processing unit 101, and the substrate W is polished by the CMP module 1A. The polished substrate W is transported to the cleaning modules 8, 9, and 10 of the first processing unit 101 by the processing transporter 5 of the first processing unit 101, so that the substrate W is cleaned by the cleaning modules 8, 9, and 10. The cleaned substrate W is transported by the relay transporter 6 of the first processing unit 101 to the drying module 11, so that the substrate W is dried by the drying module 11. The dried substrate W is transported to the second position P2 of the substrate transporter 14 by the relay transporter 6 of the first processing unit 101.

The substrate W that has been processed (i.e., polished, cleaned, and dried) by the first processing unit 101 and the second processing unit 102 is transported from the second position P2 to the first position P1 by the substrate transporter 14 of the first processing unit 101. The substrate W is then returned to the cassette storage 100 by the transfer robot 55.

In the example shown in FIG. 14, two-stage polishing of the substrate W is performed by the two CMP modules 1A and 1B, while, in another example, the substrate W may be polished by only one of the two CMP modules 1A and 1B. In yet another example, the substrate W may be polished by both of the partial polishing modules 1C and 1D. In one embodiment, the cleaning module 7 may be used as the post-cleaning module instead of the pre-cleaning module. In one embodiment, at least one of the four cleaning modules 7, 8, 9, and 10 may be used as the post-cleaning module.

In one embodiment, the relay transporter 6 may not be unitized as a part of the first processing unit 101 and the second processing unit 102. Specifically, the relay transporter 6 may be coupled to the first processing unit 101 and/or the second processing unit 102 after the first processing unit 101 and the second processing unit 102 are assembled as respective units. Furthermore, the relay transporter 6 of the second processing unit 102 may have a different structure from that of the relay transporter 6 of the first processing unit 101.

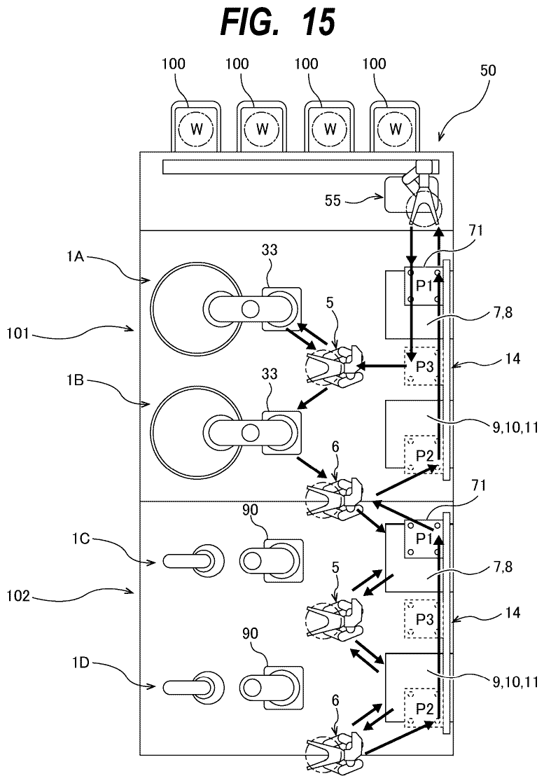

FIG. 15 is a diagram showing still another example of the transportation route and the processing sequence for a substrate W. This example shows a rescue route when a malfunction occurs in any of the cleaning modules 7, 8, 9, 10 and the drying module 11 of the first processing unit 101. After the substrate W is polished by the CMP modules 1A and 1B of the first processing unit 101, the relay transporter 6 of the first processing unit 101 removes the substrate W from the CMP module 1B, and transports the substrate W directly to the cleaning module 8 of the second processing unit 102. In the second processing unit 102, the substrate W is transported by the processing transporter 5 in the order of the cleaning modules 8, 9, and 10. Further, the substrate W is transported in the order of the drying module 11 and the second position P2 of the substrate transporter 14 by the relay transporter 6.

The substrate W that has been polished by the first processing unit 101 and cleaned and dried by the second processing unit 102 is transported from the second position P2 to the first position P1 by the substrate transporter 14 of the second processing unit 102. The substrate W is further transported to the second position P2 of the substrate transporter 14 of the first processing unit 101 by the relay transporter 6 of the first processing unit 101. The substrate W is transported from the second position P2 to the first position P1 by the substrate transporter 14 of the first processing unit 101, and is returned to the cassette storage 100 by the transfer robot 55.

In this way, even if any of the cleaning modules 7, 8, 9, 10 and the drying module 11 of the first processing unit 101 is out of order, the cleaning modules 7, 8, 9, 10 and the drying module 11 of the second processing unit 102 can be used to clean and dry the substrate W. Similarly, if any of the cleaning modules 7, 8, 9, 10 and the drying module 11 of the second processing unit 102 is out of order, the cleaning modules 7, 8, 9, 10 and the drying module 11 of the first processing unit 101 can be used to clean and dry the substrate W.

Each of the first processing unit 101 and the second processing unit 102 includes a plurality of consumables. Examples of the consumables include the polishing pad of the CMP module, a membrane for pressing a substrate against the polishing pad, a retainer ring of each polishing head of the CMP modules for retaining a substrate, a dresser disk for dressing the polishing pad, a scrub cleaning tool for cleaning a substrate, and a buff pad of the polishing head used in the partial polishing module. These consumables are replaced periodically to maintain intended polishing and cleaning performance.

Therefore, in order to replace consumables, it is necessary to stop the operations of the first processing unit 101 and the second processing unit 102 for the maintenance. However, if the operations of both the first processing unit 101 and the second processing unit 102 are stopped at the same time, the substrate processing apparatus cannot process a substrate during that time, resulting in a decrease in throughput.

Therefore, the operation controller 15 is configured to predict maintenance times (each of which is an operation time of replacing consumables) of the first processing unit 101 and the second processing unit 102, and control an operating rate of at least one of the first processing unit 101 and the second processing unit 102 so as to prevent overlapping of the maintenance times of the first processing unit 101 and the second processing unit 102. The operating rate of the processing unit is represented by the number of substrates processed by the processing unit per unit time. The unit time is a predetermined period.

The operation controller 15 is configured to calculate a first maintenance index value related to maintenance of a consumable in the first processing unit 101 and a second maintenance index value related to maintenance of a consumable in the second processing unit 102. The first maintenance index value is calculated for a consumable that is expected to reach its replacement time earliest among a plurality of consumables in the first processing unit 101. Similarly, the second maintenance index value is calculated for a consumable that is expected to reach its replacement time earliest among a plurality of consumables in the second processing unit 102.

Examples of the maintenance index value are as follows.

### Cumulative Use Time of a Consumable

When a cumulative use time of a consumable has reached a predetermined limit use time, the consumable is replaced. The cumulative use time of the consumable may be represented by the cumulative number of substrates processed using that consumable (i.e., the cumulative number of processed substrates). When the cumulative number of processed substrates for a consumable has reached a processing limit number, the consumable is replaced.

### Time to Reach the End of Service Life of Consumable

A degree of deterioration of a consumable is measured by a sensor or the like, and the operation controller 15 estimates the number of substrates that can be processed using the consumable or a time the consumable can be used. For example, a thickness of the retainer ring is measured by a measuring device, and the operation controller 15 estimates the number of processed substrates or the time required until the retainer ring wears down to a predetermined thickness. Alternatively, the operation controller 15 may determine the time to reach the end of service life based on an evaluation value (e.g., surface uniformity) regarding the processed substrate.

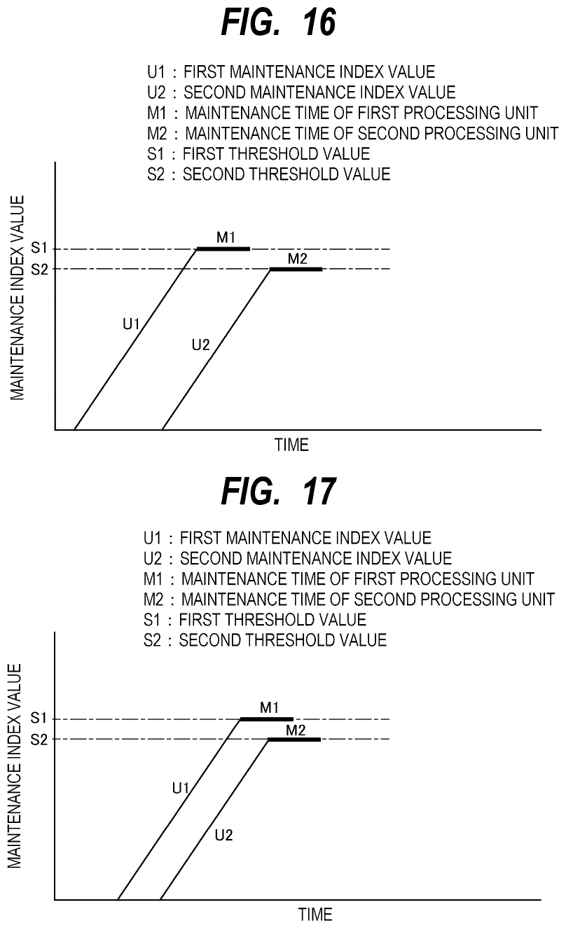

The operation controller 15 predicts the maintenance time of the first processing unit 101 and the maintenance time of the second processing unit 102 based on the first maintenance index value and the second maintenance index value. FIG. 16 is a graph showing changes in the first maintenance index value and the second maintenance index value over time. In FIG. 16, vertical axis represents the first maintenance index value and the second maintenance index value, and horizontal axis represents time.

As shown in FIG. 16, the first maintenance index value and the second maintenance index value approach a first threshold value and a second threshold value, respectively, over time. A point in time at which the first maintenance index value reaches the first threshold is an expected arrival point in time of the maintenance time M1 of the first processing unit 101, and a point in time at which the second maintenance index value reaches the second threshold is an expected arrival point in time of the maintenance time M2 of the second processing unit 102. In the example shown in FIG. 16, the first maintenance index value and the second maintenance index value change linearly, but they may change in a curved line, or in a combination of straight line and curved line. Furthermore, in the example shown in FIG. 16, the first maintenance index value and the second maintenance index value increase with time, while depending on the calculation method for the first maintenance index value and the second maintenance index value, the first maintenance index value and the second maintenance index value may decrease over time. In either case, the first maintenance index value and the second maintenance index value change over time.

In the example shown in FIG. 16, the maintenance time M1 of the first processing unit 101 and the maintenance time M2 of the second processing unit 102 do not overlap. Therefore, during the maintenance work on the first processing unit 101, the second processing unit 102 can continue processing substrates, and during the maintenance work on the second processing unit 102, the first processing unit 101 can continue processing substrates.

In an example shown in FIG. 17, the predicted maintenance time M1 of the first processing unit 101 overlaps with the predicted maintenance time M2 of the second processing unit 102. In such a case, the operations of both the first processing unit 101 and the second processing unit 102 must be stopped for the maintenance. During that time, the substrate processing apparatus cannot process a substrate, and a throughput is lowered.

Therefore, in one embodiment, if the predicted maintenance time M1 of the first processing unit 101 overlaps with the predicted maintenance time M2 of the second processing unit 102, the operation controller 15 changes the operating rate of at least one of the first processing unit 101 and the second processing unit 102 such that the predicted maintenance time M1 of the first processing unit 101 does not overlap with the predicted maintenance time M2 of the second processing unit 102.

A length of the maintenance time M1 of the first processing unit 101 and a length of the maintenance time M2 of the second processing unit 102 are determined in advance based on a time required to replace the consumable with new one, and an operating time required for break-in of the new consumable. Furthermore, if necessary, the lengths of the maintenance times M1 and M2 may be determined by further adding a time required for checking a quality of the apparatus after replacement of the consumable. Although the time required for actual maintenance varies depending on consumable, the lengths of maintenance times M1 and M2 used in the operation controller 15 to predict the maintenance times M1 and M2 are fixed lengths that have been determined in advance. In one embodiment, the lengths of the maintenance times M1 and M2 may be fixed lengths that are predetermined for each type of consumable. Therefore, the length of the maintenance time M1 may be different from the length of the maintenance time M2.

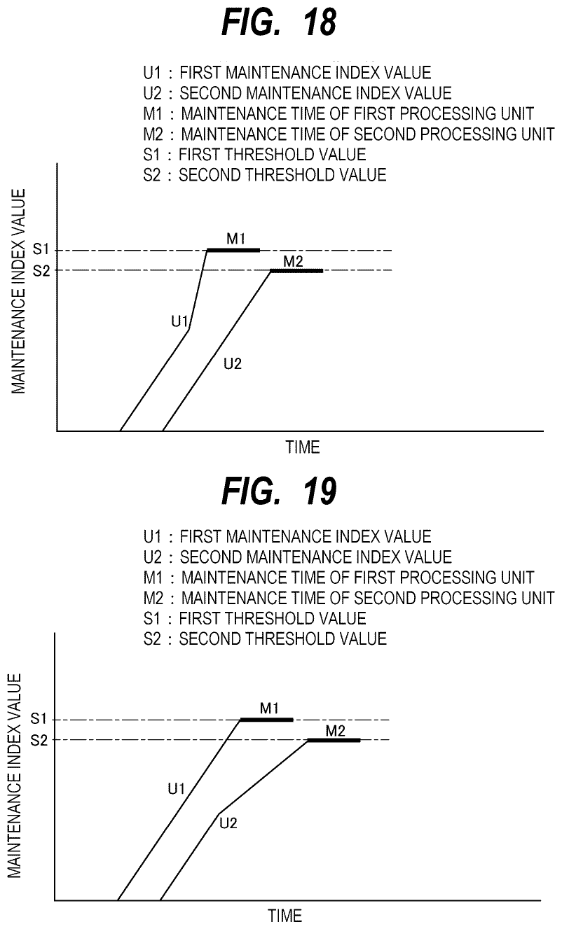

When the maintenance time M1 of the first processing unit 101 is expected to be reached earlier than the maintenance time M2 of the second processing unit 102, the operation controller 15 increases the operating rate of the first processing unit 101 as shown in FIG. 18. Changing the operating rate in this way can prevent the maintenance time M1 of the first processing unit 101 from overlapping with the maintenance time M2 of the second processing unit 102.

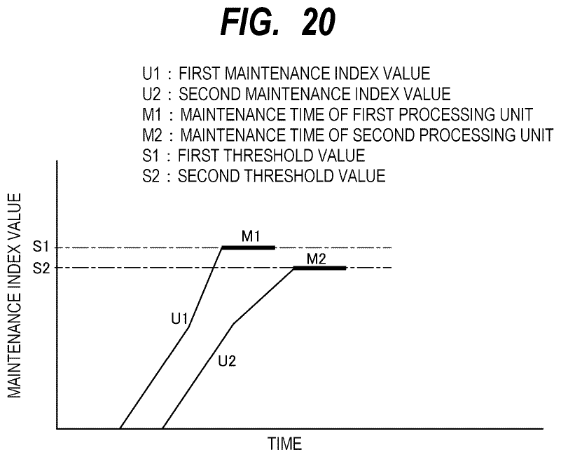

In another embodiment, as shown in FIG. 19, the operation controller 15 may lower the operating rate of the second processing unit 102 such that the maintenance time M1 of the first processing unit 101 does not overlap with the maintenance time M2 of the second processing unit 102. Alternatively, as shown in FIG. 20, the operation controller 15 may increase the operating rate of the first processing unit 101 and lower the operating rate of the second processing unit 102 such that the maintenance time M1 of the first processing unit 101 does not overlap with the maintenance time M2 of the second processing unit 102. In this case, a timing of increasing the operating rate of the first processing unit 101 and a timing of lowering the operating rate of the second processing unit 102 may be different.

If the maintenance time M2 of the second processing unit 102 is expected to be reached earlier than the maintenance time M1 of the first processing unit 101, the operation controller 15 increases the operating rate of the second processing unit 102, or lowers the operating rate of the first processing unit 101, or increases the operating rate of the second processing unit 102 and lowers the operating rate of the first processing unit 101. Changing the operating rate in this way can prevent the maintenance time M1 of the first processing unit 101 from overlapping with the maintenance time M2 of the second processing unit 102.

Although not shown in the drawings, both the first processing unit 101 and the second processing unit 102 may include the partial polishing modules described above. Specifically, the first processing unit 101 shown in FIG. 2 may include two partial polishing modules, instead of the CMP modules 1A and 1B. In this configuration, the first processing unit 101 and the second processing unit 102 have a plurality of surface-processing modules of the same type.

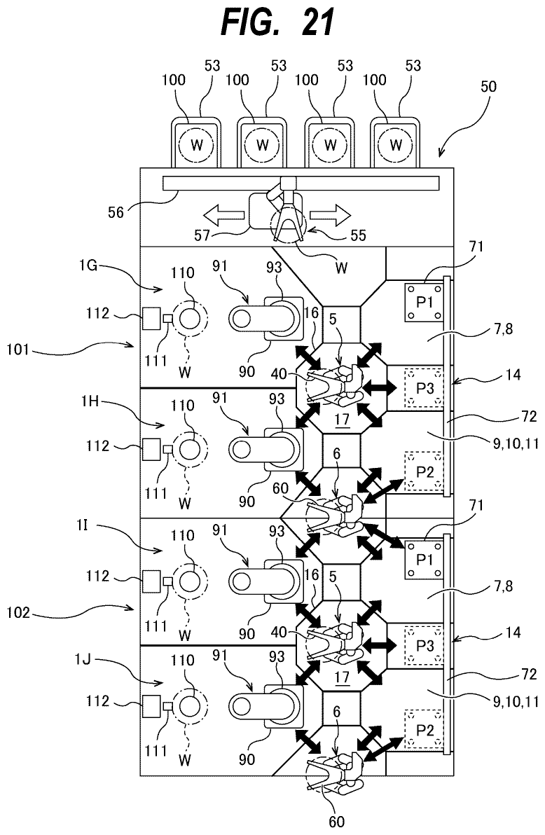

FIG. 21 is a plan view showing another embodiment of the substrate processing apparatus. Configuration, arrangement, and operation of this embodiment, unless particularly described, are the same as those of the embodiments described with reference to FIGS. 1 to 20, and thus redundant description is omitted. In the embodiment shown in FIG. 21, the first processing unit 101 includes bevel polishing modules 1G and 1H as surface-processing modules, and the second processing unit 102 also includes bevel polishing modules 1I and 1J as surface-processing modules.

The bevel polishing modules 1G, 1H, 1I, and 1J are edge polishing devices each configured to polish a peripheral edge of the substrate W. The bevel polishing modules 1G, 1H, 1I, and 1J have the same configuration. Therefore, the bevel polishing modules 1G and 1H, which are the surface-processing modules of the first processing unit 101, are of the same type as the bevel polishing modules 1I and 1J, which are the surface-processing modules of the second processing unit 102.

Since the bevel polishing modules 1G, 1H, 1I, and 1J have the same configuration, the following description focuses on the bevel polishing module 1G. The bevel polishing module 1G includes a substrate holder 110 configured to hold and rotate a substrate W, a polishing head 111 configured to polish the peripheral edge of the substrate W using a polishing tape, a polishing-tape supply mechanism 112 configured to supply the polishing tape to the polishing head 111, a substrate placement stage 90 on which the substrate W is placed, and a substrate conveyor 91 configured to convey the substrate W between the substrate placement stage 90 and the substrate holder 110. The substrate placement stage 90 is disposed outside the substrate holder 110. Configuration and operation of the substrate conveyor 91 and the substrate placement stage 90 are the same as those described with reference to FIG. 12, and detailed description thereof is omitted.

The processing transporter 5 places the substrate W onto the substrate placement stage 90 with a device surface (i.e., a surface on which devices are formed or to be formed) of the substrate W facing upward. A transfer hand 93 of the substrate conveyor 91 holds the substrate W on the substrate placement stage 90. Subsequently, a transfer arm 94 is rotated by a predetermined angle, until the transfer hand 93 holding the substrate W is moved to a position above the substrate holder 110. The substrate W is then placed on the substrate holder 110 and is held on the substrate holder 110 by vacuum suction. The peripheral edge of the substrate W is polished by the bevel polishing module 1G.

As shown in FIG. 21, when viewed from above the processing transporter 5, the two bevel polishing modules 1G and 1H (more specifically, the substrate placement stages 90 of the bevel polishing modules 1G and 1H) are located at the same distance from the processing transporter 5 of the first processing unit 101 (more specifically, a home position of the holding hand 40). Therefore, the processing transporter 5 can transport multiple substrates, polished by the two bevel polishing modules 1G and 1H, to the same cleaning module (e.g., cleaning module 8) in substantially the same transport time.

Similarly, when viewed from above the processing transporter 5, the two bevel polishing modules 1I and 1J (more specifically, the substrate placement stages 90 of the bevel polishing modules 1I and 1J) are located at the same distance from the processing transporter 5 of the second processing unit 102 (more specifically, a home position of the holding hand 40). Therefore, the processing transporter 5 can transport multiple substrates, polished by the two bevel polishing modules 1I and 1J, to the same cleaning module (e.g., cleaning module 8) in substantially the same transport time.

Furthermore, when viewed from above the processing transporter 5, the distance from the bevel polishing modules 1G and 1H of the first processing unit 101 to the processing transporter 5 of the first processing unit 101 is the same as the distance from the bevel polishing modules 1I and 1J of the second processing unit 102 to the processing transporter 5 of the second processing unit 102.

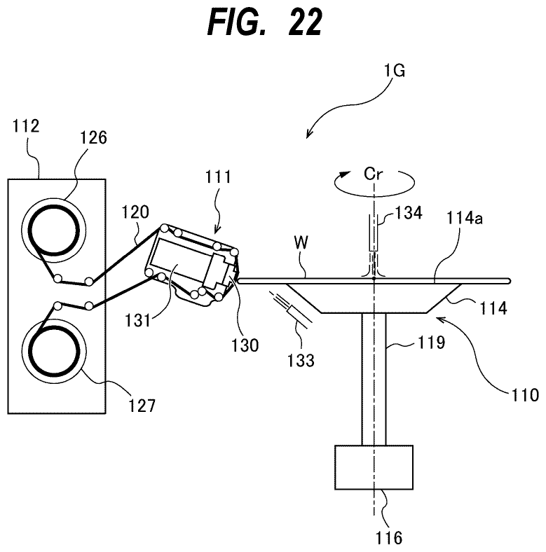

FIG. 22 is a side view showing one embodiment of configurations of the bevel polishing module 1G. In FIG. 22, the substrate placement stage 90 and the substrate conveyor 91 are not depicted. As shown in FIG. 22, the bevel polishing module 1G includes the substrate holder 110 configured to hold and rotate the substrate W, and the polishing head 111 configured to press the polishing tape 120 against the peripheral edge of the substrate W on the substrate holder 110 to polish the substrate W. The substrate holder 110 includes a rotational stage 114 having a substrate holding surface 114a, and a stage rotating mechanism 116 configured to rotate the rotational stage 114 about its central axis Cr. The polishing head 111 is disposed adjacent to the rotational stage 114.

The rotational stage 114 is configured to be able to hold the substrate W on the substrate holding surface 114a by vacuum suction. The rotational stage 114 is coupled to a stage shaft 119, which is in turn coupled to the stage rotating mechanism 116. The stage rotating mechanism 116 includes a motor and is configured to rotate the stage shaft 119 and the rotational stage 114 together about the central axis Cr of the rotational stage 114.

The substrate W is placed on the substrate holding surface 114a of the rotational stage 114 by the transfer hand 93 (see FIG. 21) such that the center of the substrate W coincides with the central axis Cr of the rotational stage 114. The substrate W, with its device surface facing upward, is held on the substrate holding surface 114a of the rotational stage 114. The stage rotating mechanism 116 rotates the substrate W about the central axis Cr of the rotational stage 114 (i.e., a central axis of the substrate W).

The bevel polishing module 1G further includes the polishing-tape supply mechanism 112 configured to supply and collect the polishing tape 120 to and from the polishing head 111. The polishing-tape supply mechanism 112 includes a tape feeding reel 126 that supplies the polishing tape 120 to the polishing head 111 and a tape take-up reel 127 that collects the polishing tape 120 used for polishing the substrate W. Tension motors, not shown, are coupled to the tape feeding reel 126 and tape take-up reel 127, respectively. The tension motors apply predetermined torques to the tape feeding reel 126 and tape take-up reel 127, thereby applying a predetermined tension to the polishing tape 120.

The polishing tape 120 is supplied to the polishing head 111 such that a polishing surface of the polishing tape 120 faces the peripheral edge of the substrate W. The polishing tape 120 is supplied from the tape feeding reel 126 to the polishing head 111, and the polishing tape 120 that has been used for polishing the substrate W is collected by the tape take-up reel 127.

The polishing head 111 includes a pressing member 130 configured to press the polishing surface of the polishing tape 120 against the substrate W and an air cylinder 131 as an actuator configured to move the pressing member 130 toward the peripheral edge of the substrate W. Controlling an air pressure supplied to the air cylinder 131 allows for adjustment of a pressing force of the polishing tape 120 against the substrate W.

The bevel polishing module 1G includes a lower supply nozzle 133 configured to supply a liquid to a lower surface of the substrate W and an upper supply nozzle 134 configured to supply a liquid to an upper surface of the substrate W. Examples of the liquid supplied to the substrate W include pure water. During polishing of the substrate W, the lower supply nozzle 133 supplies the liquid to the lower surface, and the upper supply nozzle 134 supplies the liquid to the upper surface of the substrate W.

The bevel polishing module 1G further includes a tilting mechanism (not shown) configured to tilt the polishing head 111 with respect to the substrate holding surface 114a of the rotational stage 114. The polishing head 111 can polish the peripheral edge of the substrate W while changing a tilt angle or keeping a predetermined tilt angle.

The peripheral edge of the substrate W is polished as follows. While the upper supply nozzle 134 and the lower supply nozzle 133 supply the liquid (e.g., pure water) onto the upper and lower surfaces of the substrate W, the stage rotating mechanism 116 rotates the rotational stage 114 and the substrate W. The air cylinder 131 of the polishing head 111 moves the pressing member 130 toward the peripheral edge of the substrate W, thus pressing the polishing tape 120 against the substrate W. As a result, the polishing head 111 polishes the peripheral edge of the substrate W with the polishing tape 120.

In the embodiment shown in FIG. 21, the first processing unit 101 includes the two bevel polishing modules 1G and 1H, and the second processing unit 102 includes the two bevel polishing modules 1I and 1J. The substrate processing apparatus can polish the peripheral edge of the substrate W using one or more of these bevel polishing modules 1G, 1H, 1I, and 1J. For example, the bevel polishing module 1G may perform rough polishing of the peripheral edge of the substrate W using a polishing tape for rough polishing, and the bevel polishing module 1H may perform finish-polishing of the peripheral edge of the substrate using a polishing tape for finish-polishing. The embodiment of the transportation route for the substrate W described with reference to FIGS. 13 to 15 can be applied to the embodiment shown in FIG. 21.

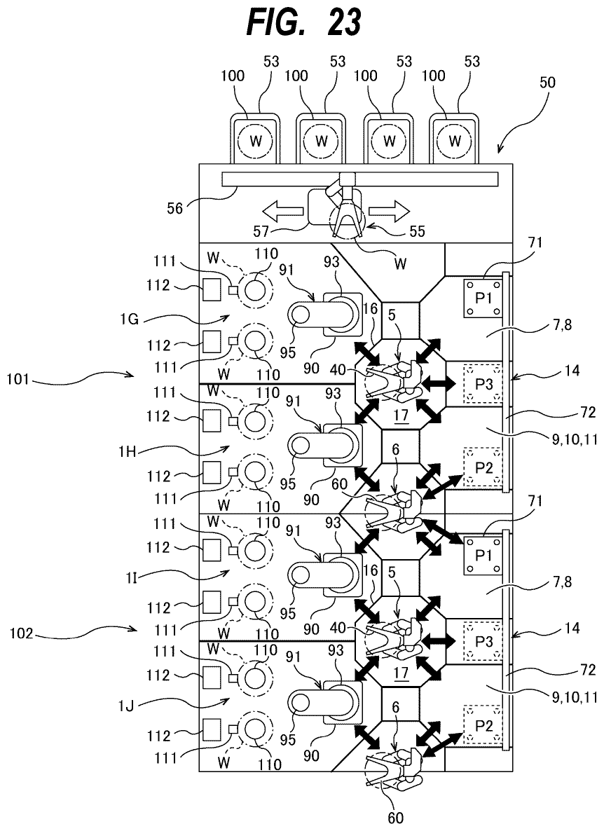

FIG. 23 is a plan view showing a further embodiment of the substrate processing apparatus. Configuration, arrangement, and operation of this embodiment, which will not be particularly described, are the same as those of the embodiments described with reference to FIGS. 21 and 22, and therefore redundant description is omitted. As shown in FIG. 23, each of the bevel polishing modules 1G to 1J includes a common substrate placement stage 90 and a common substrate conveyor 91, two substrate holders 110, two polishing heads 111, and two polishing-tape supply mechanisms 112. Although not shown, the bevel polishing module 1G includes two lower supply nozzles 133 and two upper supply nozzles 134 as described with reference to FIG. 22.

The substrate conveyor 91 can selectively transfer the substrate W, received from the substrate placement stage 90, to either one of the two substrate holders 110. Specifically, the transfer hand 93 holding the substrate W can transfer the substrate W to either one of the two substrate holders 110 by rotating in one direction or the opposite direction about the arm shaft 95.

One of the first processing unit 101 and the second processing unit 102 may include, as the surface-processing module, the CMP module described above instead of the bevel polishing module, and the other of the first processing unit 101 and the second processing unit 102 may include the bevel polishing module as the surface-processing module.

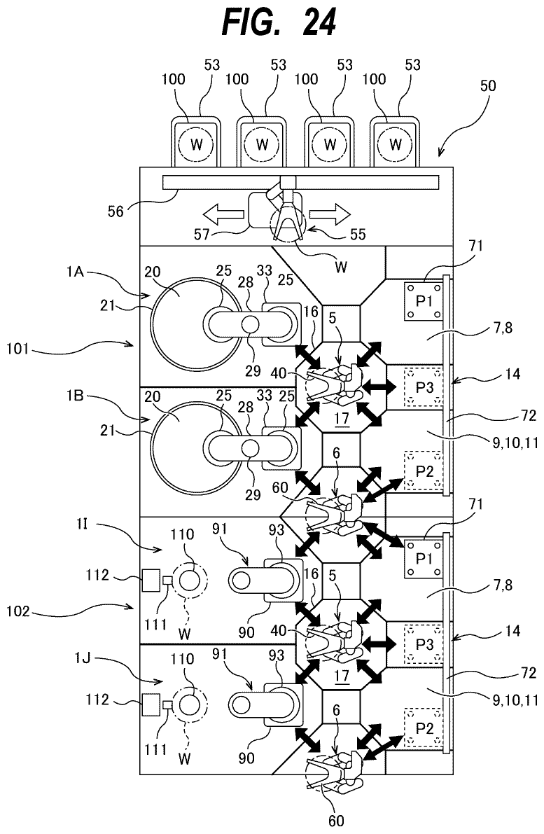

FIG. 24 is a plan view showing an embodiment in which the first processing unit 101 includes the CMP modules 1A and 1B as the surface-processing modules, and the second processing unit 102 includes the bevel polishing modules 1I and 1J as the surface-processing modules. In one embodiment, the substrate W is sequentially polished by at least one of the CMP modules 1A, 1B and at least one of the bevel polishing modules 1I, 1J. For example, the substrate W may be polished by the CMP modules 1A, 1B, and then the peripheral edge of the substrate W may be polished by either of the bevel polishing modules 1I, 1J. In another example, the peripheral edge of the substrate W may be polished by either of the bevel polishing modules 1I, 1J, and then the substrate W may be polished by the CMP modules 1A, 1B. After polishing of the substrate W, the substrate W is cleaned by the cleaning modules 8, 9, and 10 and dried by the drying module 11. The cleaning module 7 may be used for pre-cleaning or post-cleaning of the substrate W.

Although not shown, the first processing unit 101 and the second processing unit 102 may include a combination of the bevel polishing module and the partial polishing module described above as the surface-processing modules.

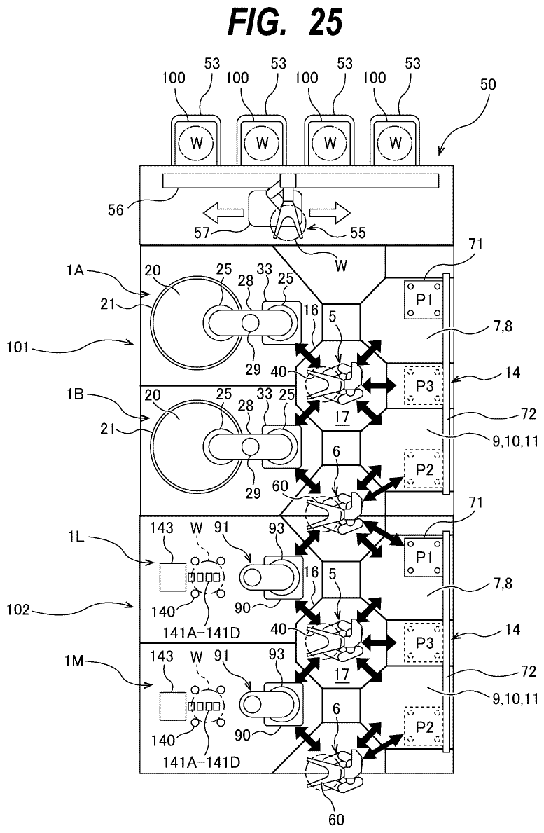

FIG. 25 is a plan view showing still another embodiment of the substrate processing apparatus. Configuration, arrangement, and operation of this embodiment, which will not be particularly described, are the same as those of the embodiments described with reference to FIGS. 1 to 20, and therefore redundant description is omitted. In the embodiment shown in FIG. 25, the first processing unit 101 includes the above-described CMP modules 1A and 1B as the surface-processing modules, and the second processing unit 102 includes backside polishing modules 1L and 1M as the surface-processing modules.

Since the backside polishing modules 1L and 1M have the same configuration, the backside polishing module 1L will be described. The backside polishing module 1L includes a substrate holder 140 configured to hold and rotate the substrate W, a plurality of polishing heads 141A, 141B, 141C, and 141D configured to polish the backside of the substrate W with a polishing tape, a polishing-tape supply mechanism 143 configured to supply the polishing tape to the polishing heads 141A to 141D, the substrate placement stage 90 on which the substrate W, transported by the processing transporter 5, is placed, and the substrate conveyor 91 configured to transport the substrate W between the substrate placement stage 90 and the substrate holder 140. The substrate placement stage 90 is located outwardly of the substrate holder 140. Configuration and operation of the substrate conveyor 91 and the substrate placement stage 90 are the same as those described with reference to FIG. 12, and therefore detailed description is omitted.

The processing transporter 5 places the substrate W onto the substrate placement stage 90 with the backside of the substrate W facing downward. The transfer hand 93 of the substrate conveyor 91 holds the substrate W on the substrate placement stage 90. The transfer arm 94 is then rotated by a predetermined angle, until the transfer hand 93 holding the substrate W is moved to a position above the substrate holder 140. Then, the substrate W is held by the substrate holder 140. The backside of the substrate W is polished by the backside polishing module 1L.

As shown in FIG. 25, when viewed from above the processing transporter 5, the two backside polishing modules 1L and 1M (more specifically, the substrate placement stages 90 of the backside polishing modules 1L and 1M) are located at the same distance from the processing transporter 5 of the second processing unit 102 (more specifically, a home position of the holding hand 40). Therefore, the processing transporter 5 can transport multiple substrates, polished by the two backside polishing modules 1L and 1M, to the same cleaning module (for example, the cleaning module 8) in substantially the same transport time.

Furthermore, when viewed from above the processing transporter 5, the distance from the CMP modules 1A and 1B of the first processing unit 101 to the processing transporter 5 of the first processing unit 101 is the same as the distance from the backside polishing modules 1L and 1M of the second processing unit 102 to the processing transporter 5 of the second processing unit 102.

In one embodiment, the substrate W is sequentially polished by at least one of the CMP modules 1A, 1B and at least one of the backside polishing modules 1L, 1M. For example, the substrate W may be polished by the CMP modules 1A, 1B, and then the backside of the substrate W may be polished by the backside polishing modules 1L, 1M. In another example, the backside of the substrate W may be polished by the backside polishing modules 1L, 1M, and then the substrate W may be polished by the CMP modules 1A, 1B. After polishing of the substrate W, the substrate W is cleaned by the cleaning modules 8, 9, and 10 and dried by the drying module 11. The cleaning module 7 may be used for pre-cleaning or post-cleaning of the substrate W.

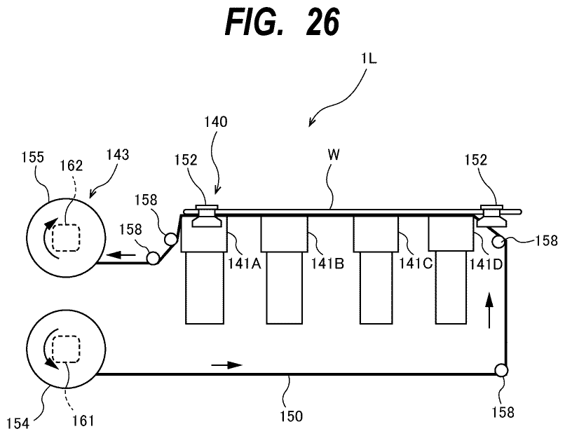

FIG. 26 is a side view showing one embodiment of configuration of the backside polishing module 1L. In FIG. 26, the substrate placement stage 90 and the substrate conveyor 91 are not depicted. As shown in FIG. 26, the backside polishing module 1L includes the substrate holder 140 configured to hold and rotate the substrate W, the plurality of polishing heads 141A, 141B, 141C, and 141D configured to bring the polishing tape 150 into contact with the backside of the substrate W, held by the substrate holder 140, to polish the backside of the substrate W, and the polishing-tape supply mechanism 143 configured to supply the polishing tape 150 to the polishing heads 141A to 141D and collect the polishing tape 150 from the polishing heads 141A to 141D. The backside of the substrate W is a surface opposite to the device surface of the substrate W. Specifically, the backside of the substrate W is a non-device surface of the substrate W where no device is formed or no device is to be formed.

The substrate holder 140 includes a plurality of rollers 152 that can contact the peripheral edge of the substrate W and a roller rotating device (not shown) configured to rotate the plurality of rollers 152 at the same speed. In the present embodiment, four rollers 152 are provided along the peripheral edge of the substrate W, while only two rollers 152 are shown in FIG. 26. The number of rollers 152 is not limited to this embodiment, and three rollers 152 or five or more rollers 152 may be provided.

The plurality of polishing heads 141A to 141D are arranged under the substrate W held by the substrate holder 140. These polishing heads 141A to 141D are arranged in the radial direction of the substrate W. In the present embodiment, four polishing heads 141A to 141D are provided, while the number of polishing heads is not limited to this embodiment. In one embodiment, a single polishing head may be provided.

The polishing-tape supply mechanism 143 includes a tape feeding reel 154 to which one end of the polishing tape 150 is coupled, a tape take-up reel 155 to which the other end of the polishing tape 150 is coupled, and a plurality of guide rollers 158 that guide the advancing direction of the polishing tape 150. The tape feeding reel 154 and the tape take-up reel 155 are coupled to reel motors 161 and 162, respectively.

When the tape take-up reel 155 is rotated in a direction indicated by arrow, the polishing tape 150 advances from the tape feeding reel 154 via the polishing heads 141A, 141B, 141C, and 141D to the tape take-up reel 155. The polishing tape 150 is supplied over the polishing heads 141A, 141B, 141C, and 141D such that a polishing surface of the polishing tape 150 faces the backside of the substrate W. The reel motor 161 can apply tension to the polishing tape 150 by exerting a predetermined torque on the tape feeding reel 154. The reel motor 162 is controlled so as to feed the polishing tape 150 at a constant speed.

The backside of the substrate W is polished as follows. While the peripheral edge of the substrate W is held by the plurality of rollers 152, the plurality of rollers 152 are rotated, so that the substrate W is rotated. While the polishing tape 150 is supplied to the polishing heads 141A, 141B, 141C, and 141D by the polishing-tape supply mechanism 143, the polishing heads 141A, 141B, 141C, and 141D press the polishing tape 150 against the backside of the substrate W to polish the backside of the substrate W.

In the embodiment shown in FIG. 25, the first processing unit 101 includes the CMP modules 1A and 1B as the surface-processing modules, and the second processing unit 102 includes the backside polishing modules 1L and 1M as the surface-processing modules. However, the types of surface-processing modules and their combinations are not limited to this embodiment. For example, the first processing unit 101 and the second processing unit 102 may include a combination of the backside polishing module as the surface-processing module and other type of the surface-processing module which is the partial polishing module or the bevel polishing module. In another embodiment, the first processing unit 101 and the second processing unit 102 may include only a plurality of backside polishing modules as the surface-processing modules.

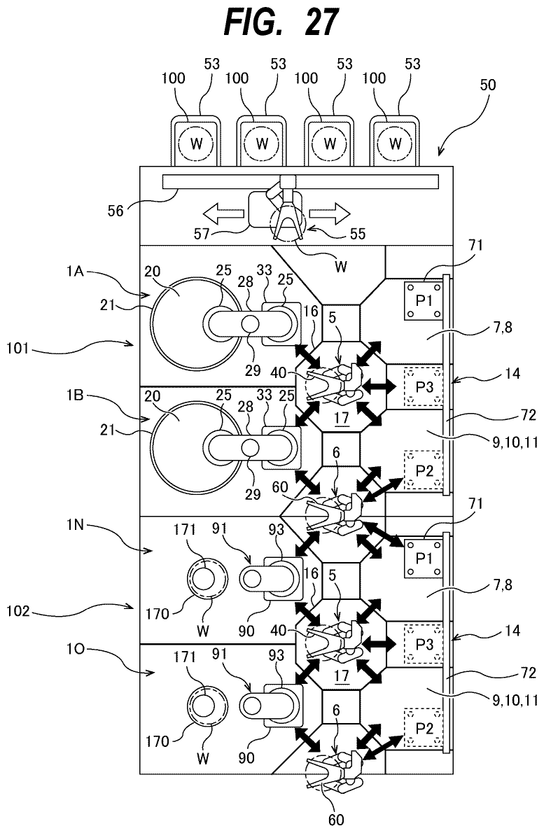

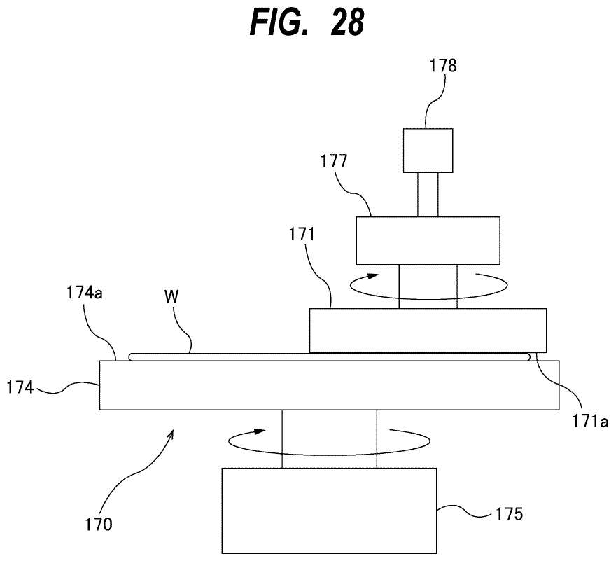

FIG. 27 is a plan view showing still another embodiment of the substrate processing apparatus. Configuration, arrangement, and operation of this embodiment, which will not be particularly described, are the same as those of the embodiments described with reference to FIGS. 1 to 20, and therefore redundant description is omitted. In the embodiment shown in FIG. 27, the first processing unit 101 includes the CMP modules 1A and 1B as the surface-processing modules, and the second processing unit 102 includes thinning modules 1N and 1O as the surface-processing modules.

Since the thinning modules 1N and 1O have the same configuration, the thinning module 1N will be described. The thinning module 1N is a grinding device configured to thin the substrate W by grinding the non-device surface of the substrate W (the surface where no device is formed or no device is to be formed). The thinning module 1N includes a substrate holder 170 configured to hold and rotate the substrate W, a grinding head 171 configured to grind the substrate W, a substrate placement stage 90 on which the substrate W, transported by the processing transporter 5, is placed, and a substrate conveyor 91 configured to transport the substrate W between the substrate placement stage 90 and the substrate holder 170. The substrate placement stage 90 is located outwardly of the substrate holder 170. Configuration and operation of the substrate conveyor 91 and the substrate placement stage 90 are the same as those described with reference to FIG. 12, and therefore detailed description is omitted.

The processing transporter 5 places the substrate W onto the substrate placement stage 90 with the non-device surface (i.e., the surface to be ground) of the substrate W facing upward. The transfer hand 93 of the substrate conveyor 91 holds the substrate W on the substrate placement stage 90. The transfer arm 94 is then rotated by a predetermined angle, until the transfer hand 93 holding the substrate W is moved to a position above the substrate holder 170. Then, the substrate W is held by the substrate holder 170. The substrate W is then ground by the thinning module 1N.

As shown in FIG. 27, when viewed from above the processing transporter 5, the two thinning modules 1N and 1O (more specifically, the substrate placement stages 90 of the thinning modules 1N and 1O) are located at the same distance from the processing transporter 5 of the second processing unit 102 (more specifically, a home position of the holding hand 40). Therefore, the processing transporter 5 can transport multiple substrates, ground by the two thinning modules 1N and 1O, to the same cleaning module (for example, the cleaning module 8) in substantially the same transport time.

Furthermore, when viewed from above the processing transporter 5, the distance from the CMP modules 1A and 1B of the first processing unit 101 to the processing transporter 5 of the first processing unit 101 is the same as the distance from the thinning modules 1N and 1O of the second processing unit 102 to the processing transporter 5 of the second processing unit 102.

In one embodiment, the substrate W is sequentially polished and ground by at least one of the CMP modules 1A, 1B and at least one of the thinning modules 1N, 1O. For example, the substrate W may be polished by the CMP modules 1A, 1B, and then ground by the thinning modules 1N, 1O. In another example, the substrate W may be ground by the thinning modules 1N, 1O, and then polished by the CMP modules 1A, 1B. After polishing and grinding of the substrate W, the substrate W is cleaned by the cleaning modules 8, 9, and 10 and dried by the drying module 11. The cleaning module 7 may be used for pre-cleaning or post-cleaning of the substrate W.

FIG. 28 is a side view showing one embodiment of configuration of the thinning module 1N. In FIG. 28, the substrate placement stage 90 and the substrate conveyor 91 are not depicted. As shown in FIG. 28, the thinning module 1N includes the substrate holder 170 configured to hold and rotate the substrate W. The substrate holder 170 includes a holding stage 174 configured to hold the substrate W, a stage rotating device 175 configured to rotate the holding stage 174, a grinding head 171 configured to grind the substrate W on the holding stage 174, a grinding-tool rotating device 177 configured to rotate the grinding head 171, and a grinding-tool pressing device 178 configured to press the grinding head 171 against the substrate W on the holding stage 174. The grinding head 171 has a grinding surface 171a to which grinding particles, such as diamond particles, are fixed. The holding stage 174 is configured to hold the substrate W by vacuum attaction or the like on its stage surface 174a.

When the stage rotating device 175 rotates the holding stage 174, the substrate W on the holding stage 174 rotates. While the grinding head 171 is rotated by the grinding-tool rotating device 177, the grinding-tool pressing device 178 presses the grinding surface 171a of the grinding head 171 against the substrate W. The substrate W is ground by the grinding head 171, so that the substrate W is thinned.

In the embodiment shown in FIG. 27, the first processing unit 101 includes the CMP modules 1A and 1B as the surface-processing modules, and the second processing unit 102 includes the thinning modules 1N and 1O as the surface-processing modules. However, the type of surface-processing modules and their combinations are not limited to this embodiment. For example, the first processing unit 101 and the second processing unit 102 may include a combination of the thinning module as the surface-processing modules and other type of surface-processing module which is one of the partial polishing module, the bevel polishing module, and backside polishing module. In another embodiment, the first processing unit 101 and the second processing unit 102 may include only a plurality of thinning modules as the surface-processing modules.

The embodiments of the surface-processing modules described with reference to FIGS. 1 to 28 can be appropriately combined. Specifically, the surface-processing module of one of the first processing unit 101 and the second processing unit 102 may be any one of the CMP module, the bevel polishing module, the partial polishing module, the backside polishing module, and the thinning module, and the surface-processing module of the other of the first processing unit 101 and the second processing unit 102 may be any one of the bevel polishing module, the partial polishing module, the backside polishing module, and the thinning module.

The processing of the substrate in the first processing unit 101 and the processing of the substrate in the second processing unit 102 may be performed in parallel or sequentially. The order of the substrate processing in the first processing unit 101 and the second processing unit 102 is not particularly limited. In one example, the substrate may be first processed by the first processing unit 101 and then processed by the second processing unit 102. In another example, the substrate may be first processed by the second processing unit 102 and then processed by the first processing unit 101.

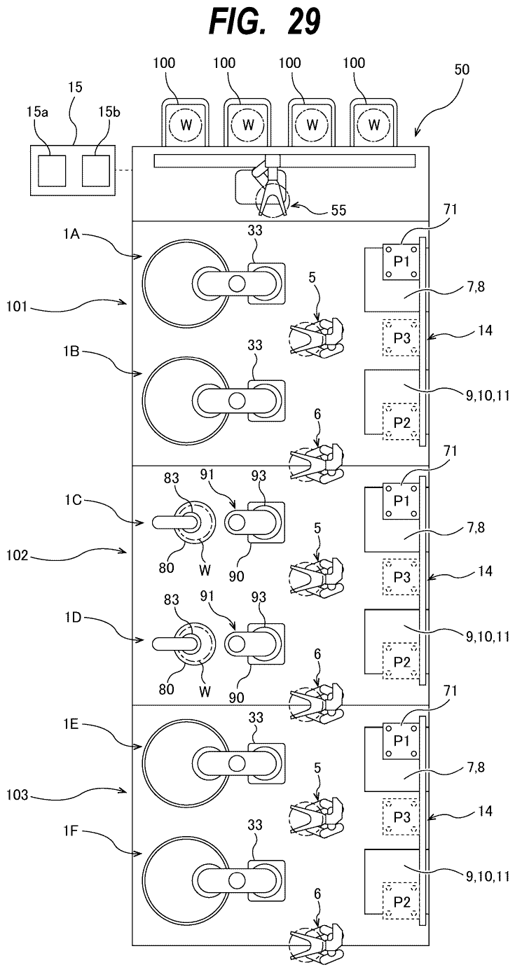

FIG. 29 is a plan view showing another embodiment of the substrate processing apparatus. Configuration, arrangement, and operation of this embodiment, which will not be particularly described, are the same as those of the embodiments described with reference to FIGS. 1 to 15, and therefore redundant description is omitted. The substrate processing apparatus in the embodiment shown in FIG. 29 further includes a third processing unit 103 in addition to the first processing unit 101 and the second processing unit 102. The third processing unit 103 is coupled to the second processing unit 102. The first processing unit 101, the second processing unit 102, and the third processing unit 103 are arranged in series.

The third processing unit 103 has the same components as the first processing unit 101. Specifically, the first processing unit 101 includes the CMP modules 1A and 1B as the surface-processing modules for performing surface processing of the substrate W, the second processing unit 102 includes the partial polishing modules 1C and 1D as the surface-processing modules for performing surface processing of the substrate W, and the third processing unit 103 includes CMP modules 1E and 1F as surface-processing modules. In FIG. 29, illustration of the wall 16 and the transfer area 17 described with reference to FIG. 3 is omitted.

Each of the first processing unit 101, the second processing unit 102, and the third processing unit 103 is a unitized assembly. In one embodiment, the third processing unit 103 is removably coupled to the second processing unit 102 such that the entirety of the third processing unit 103 is separable from the second processing unit 102. Furthermore, it is also possible to couple one or more additional processing units to the third processing unit 103. Specifically, four or more processing units including the first processing unit 101, the second processing unit 102, and the third processing unit 103 may be coupled in series. Operations of a plurality of processing units including at least the first processing unit 101, the second processing unit 102, and the third processing unit 103 are controlled by the operation controller 15.

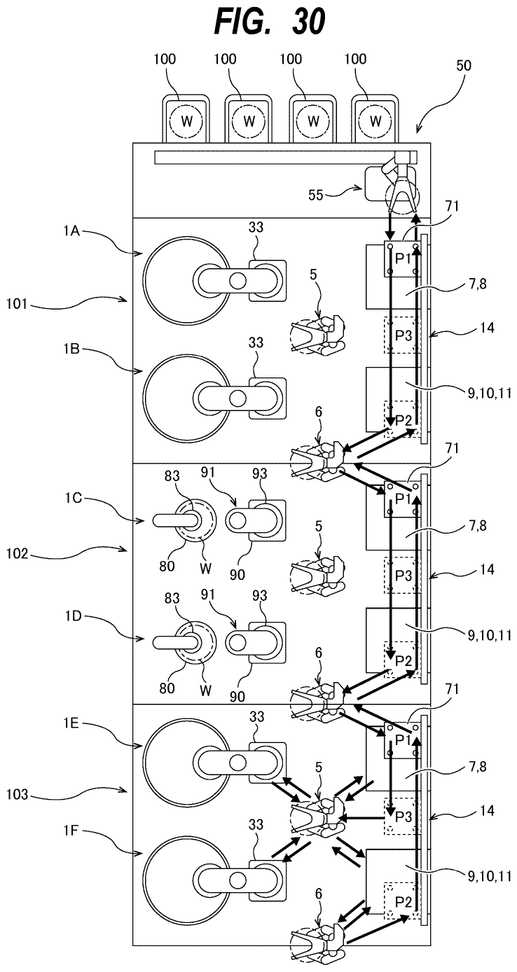

Although duplicate explanations will be omitted, the substrate processing apparatus of the embodiment shown in FIG. 29 can process multiple substrates in the first processing unit 101 and the second processing unit 102, as described with reference to FIGS. 13 and 14. The substrate processing apparatus of the embodiment shown in FIG. 29 can also transport a substrate in the rescue transportation route described with reference to FIG. 15. Furthermore, as shown in FIG. 30, the substrate processing apparatus can process (polish, clean, dry) a substrate in the third processing unit 103.

In an example shown in FIG. 30, the substrate W is transported from the cassette storage 100 to the first position P1 of the substrate transporter 14 of the first processing unit 101 by the transfer robot 55. The substrate W is transported from the first position P1 to the second position P2 by the substrate transporter 14. The substrate W is transported from the second position P2 of the substrate transporter 14 of the first processing unit 101 to the first position P1 of the substrate transporter 14 of the second processing unit 102 by the relay transporter 6 of the first processing unit 101. The substrate W is transported from the first position P1 to the second position P2 by the substrate transporter 14 of the second processing unit 102. Further, the substrate W is transported from the second position P2 of the substrate transporter 14 of the second processing unit 102 to the first position P1 of the substrate transporter 14 of the third processing unit 103 by the relay transporter 6 of the second processing unit 102. The substrate transporter 14 of the third processing unit 103 transports the substrate W from the first position P1 to the third position P3.

In the third processing unit 103, the substrate W is transported in the order of the cleaning module (pre-cleaning module) 7, the CMP module 1E, the CMP module 1F, and the cleaning modules 8, 9, and 10 by the processing transporter 5. Further, the substrate W is transported in the order of the drying module 11 and the second position P2 of the substrate transporter 14 by the relay transporter 6.

In one embodiment, the substrate W may be polished by only one of the two CMP modules 1E, 1F. In one embodiment, the cleaning module 7 may be used as the post-cleaning module rather than the pre-cleaning module. In one embodiment, at least one of the four cleaning modules 7, 8, 9, 10 may be used as the post-cleaning module.

The substrate W that has been processed (polished, cleaned, dried) by the third processing unit 103 is transported from the second position P2 to the first position P1 by the substrate transporter 14 of the third processing unit 103, and is then transported to the second position P2 of the substrate transporter 14 of the second processing unit 102 by the relay transporter 6 of the second processing unit 102. The substrate W is transported from the second position P2 to the first position P1 by the substrate transporter 14 of the second processing unit 102, and then transported to the second position P2 of the substrate transporter 14 of the first processing unit 101 by the relay transporter 6 of the first processing unit 101. The substrate W is transported from the second position P2 to the first position P1 by the substrate transporter 14 of the first processing unit 101, and is returned to the cassette storage 100 by the transfer robot 55.

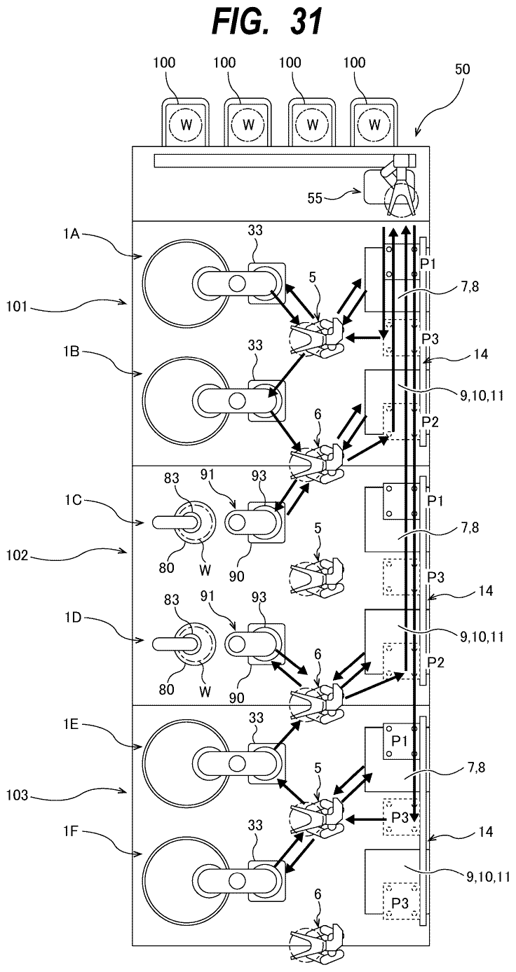

FIG. 31 is a diagram showing another example of the substrate transport route and processing sequence. Detailed operations not specifically described are the same as those in the embodiments described above. In this example, two substrates are processed. A first substrate is transported by the substrate transporter 14 of the first processing unit 101 to the third position P3 of the first processing unit 101. The first substrate is transported by the processing transporter 5 of the first processing unit 101 in the order of the cleaning module (pre-cleaning module) 7, the CMP module 1A, and the CMP module 1B of the first processing unit 101, so that pre-cleaning and polishing of the first substrate are performed by the cleaning module 7 and CMP modules 1A and 1B.

The polished first substrate is transported from the CMP module 1B to the partial polishing module 1C of the second processing unit 102 by the relay transporter 6 of the first processing unit 101, and partial polishing of the first substrate is performed by the partial polishing module 1C. The first substrate is then transported to the cleaning modules 9 and 10 and the drying module 11 of the first processing unit 101 by the relay transporter 6 of the first processing unit 101, so that the first substrate is cleaned and dried. Transport of the first substrate from the cleaning module 9 to the cleaning module 10 may be performed by the processing transporter 5 of the first processing unit 101 instead of the relay transporter 6.

In one embodiment, before the first substrate is transported to the cleaning modules 9 and 10 and the drying module 11 of the first processing unit 101, the relay transporter 6 of the first processing unit 101 may transport the first substrate to the cleaning module 8 of the second processing unit 102, so that the first substrate may be cleaned by the cleaning module 8. In this case, the first substrate is cleaned and dried by the cleaning module 8 of the second processing unit 102 and the cleaning modules 9 and 10 and the drying module 11 of the first processing unit 101.

The dried first substrate is transported to the second position P2 of the first processing unit 101 by the relay transporter 6 of the first processing unit 101, and further transported from the second position P2 to the first position P1 by the substrate transporter 14 of the first processing unit 101. The processed (i.e., polished, cleaned, and dried) first substrate is then returned to the cassette storage 100 by the transfer robot 55.

A second substrate is transported from the first position P1 of the first processing unit 101 to the third position P3 of the third processing unit 103 by the substrate transporter 14 and the relay transporter 6 of the first processing unit 101, the substrate transporter 14 and the relay transporter 6 of the second processing unit 102, and the substrate transporter 14 of the third processing unit 103. The second substrate is transported by the processing transporter 5 of the third processing unit 103 in the order of the cleaning module (pre-cleaning module) 7, the CMP module 1F, and the CMP module 1E of the third processing unit 103, so that pre-cleaning and polishing of the second substrate are performed by the cleaning module 7 and the CMP modules 1F and 1E.

The polished second substrate is transported from the CMP module 1E to the partial polishing module 1D of the second processing unit 102 by the relay transporter 6 of the second processing unit 102, so that partial polishing of the second substrate is performed by the partial polishing module 1D. The second substrate is then transported to the cleaning modules 9 and 10 and the drying module 11 of the second processing unit 102 by the relay transporter 6 of the second processing unit 102, so that the second substrate is cleaned and dried. Transport of the second substrate from the cleaning module 9 to the cleaning module 10 may be performed by the processing transporter 5 of the second processing unit 102 instead of the relay transporter 6.

In one embodiment, before the second substrate is transported to the cleaning modules 9 and 10 and the drying module 11 of the second processing unit 102, the relay transporter 6 of the second processing unit 102 may transport the second substrate to the cleaning module 8 of the third processing unit 103, so that the second substrate may be cleaned by the cleaning module 8. In this case, the second substrate is cleaned and dried by the cleaning module 8 of the third processing unit 103 and the cleaning modules 9 and 10 and the drying module 11 of the second processing unit 102.

The dried second substrate is transported to the second position P2 of the second processing unit 102 by the relay transporter 6 of the second processing unit 102. Furthermore, the second substrate is transported to the first position P1 of the first processing unit 101 by the substrate transporter 14 of the second processing unit 102, the relay transporter 6 and the substrate transporter 14 of the first processing unit 101. The processed (i.e., polished, cleaned, and dried) second substrate is then returned to the cassette storage 100 by the transfer robot 55.

The first substrate and the second substrate may be processed in parallel, or may be processed successively. In another embodiment, the first substrate may be transported in the order of the partial polishing module 1C, the CMP module 1B, and the CMP module 1A, and the second substrate may be transported in the order of the partial polishing module 1D, the CMP module 1E, and the CMP module 1F.

The processing units 101, 102, 103 may be inseparable from each other. Multiple processing units can be combined depending on a required substrate processing sequence and processing amount. The cleaning process can be started in substantially the same time after polishing of the substrate no matter which processing unit is used. Therefore, it is possible to reduce a difference in substrate corrosion between substrates.

The embodiments described with reference to FIGS. 16 to 20 for avoiding overlapping of the maintenance times can be applied to the embodiments described with reference to FIGS. 29 to 31. Specifically, the operation controller 15 calculates a first maintenance index value related to maintenance of a consumable in the first processing unit 101, a second maintenance index value related to maintenance of a consumable in the second processing unit 102, and a third maintenance index value related to maintenance of a consumable in the third processing unit 103. The operation controller 15 predicts a maintenance time of the first processing unit 101, a maintenance time of the second processing unit 102, and a maintenance time of the third processing unit 103 based on the first maintenance index value, the second maintenance index value, and the third maintenance index value. When the predicted maintenance times of any two of the first processing unit 101, the second processing unit 102, and the third processing unit 103 overlap, the operation controller 15 changes an operating rate of at least one of the two processing units such that the predicted maintenance times of the two processing units do not overlap.

When the maintenance time of one of the two processing units is expected to be reached before the maintenance time of other of the two processing units, the operation controller 15 increases the operating rate of the one of the two processing units, or lowers the operating rate of the other of the two processing units, or increases the operating rate of the one of the two processing units and lowers the operating rate of the other of the two processing units.

For example, when the maintenance time of the second processing unit 102 is expected to be reached before the maintenance time of the third processing unit 103, the operation controller 15 increases the operating rate of the second processing unit 102, or lowers the operating rate of the third processing unit 103, or increases the operating rate of the second processing unit 102 and lowers the operating rate of the third processing unit 103. When the maintenance time of the first processing unit 101 is expected to overlap with the maintenance time of the third processing unit 103, the operation controller 15 changes the operating rate of at least one of the first processing unit 101 and the third processing unit 103 in the same way, so that the maintenance times of the first processing unit 101 and the third processing unit 103 do not overlap.

Changing the operating rate in this way enables two of the three processing units 101, 102, 103 to continue processing substrates while maintenance is being performed on other one of the three processing units 101, 102, 103. As a result, the throughput of the substrate processing apparatus can be maintained.

In the embodiments described with reference to FIGS. 29 to 31, the first processing unit 101 includes the CMP modules 1A and 1B as the surface processing modules, the second processing unit 102 includes the partial polishing modules 1C and 1D as the surface processing modules, and the third processing unit 103 includes the CMP modules 1E and 1F as the surface processing modules. However, the type of surface processing modules and their combinations are not limited to this embodiment. Specifically, any one of the surface processing modules of the first processing unit 101, the second processing unit 102, and the third processing unit 103 may be any one of the CMP module, the bevel polishing module, the partial polishing module, the backside polishing module, and the thinning module. Another one of the surface processing modules of the first processing unit 101, the second processing unit 102, and the third processing unit 103 may be any one of the CMP module, the bevel polishing module, the partial polishing module, the backside polishing module, and the thinning module. The remaining one of the surface processing modules of the first processing unit 101, the second processing unit 102, and the third processing unit 103 may be any one of the bevel polishing module, the partial polishing module, the backside polishing module, and the thinning module.

The embodiment described with reference to FIG. 31 can be applied to combinations other than the combination of the CMP modules and the partial polishing modules. Furthermore, based on the purpose of processing the substrate, the processing order of the substrate may be appropriately changed within the scope of the above-described configuration and functions of the first processing unit 101, the second processing unit 102, and the third processing unit 103. Specifically, the embodiments of the substrate transport route and the processing order of the substrate described with reference to FIGS. 13, 14, 15, 30, and 31 are examples and may be appropriately modified.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

What is claimed is:

1. A substrate processing apparatus comprising:
a first processing unit and a second processing unit each for processing a substrate; and
a relay transporter configured to transport the substrate between the first processing unit and the second processing unit,
wherein each of the first processing unit and the second processing unit comprises:
a surface-processing module configured to perform surface processing on the substrate;
a cleaning module configured to clean the substrate;
a drying module configured to dry the cleaned substrate;
a substrate transporter extending from one side to opposite side of each processing unit, and
a processing transporter configured to transport the substrate from the substrate transporter to the surface-processing module, and from the surface-processing module to the cleaning module,
wherein the surface-processing module of one of the first processing unit and the second processing unit is any one of:
a CMP module configured to chemically mechanically polish a surface of the substrate;
a bevel polishing module configured to polish a peripheral edge of the substrate;
a partial polishing module configured to polish a portion of the surface of the substrate;
a backside polishing module configured to polish a backside of the substrate; and
a thinning module configured to thin the substrate by grinding the substrate,
wherein the surface-processing module of other of the first processing unit and the second processing unit is any one of:
the bevel polishing module;
the partial polishing module;
the backside polishing module; and
the thinning module.

2. The substrate processing apparatus according to claim 1, wherein the surface-processing module of the first processing unit is of a type different from that of the surface-processing module of the second processing unit.

3. The substrate processing apparatus according to claim 1, wherein the surface-processing module of the first processing unit is of the same type as that of the surface-processing module of the second processing unit.

4. The substrate processing apparatus according to claim 1, wherein the surface-processing module and the cleaning module are partitioned by a transfer area in which the processing transporter is arranged.

5. The substrate processing apparatus according to claim 1, wherein the relay transporter is arranged between the first processing unit and the second processing unit.

6. The substrate processing apparatus according to claim 1, wherein the substrate transporter comprises a substrate stage configured to stop at a first position, a second position, and a third position, the third position is located between the first position and the second position, and the processing transporter is configured to be accessible to the substrate stage at the third position.

7. The substrate processing apparatus according to claim 6, wherein the second position of the substrate transporter of the first processing unit is adjacent to the first position of the substrate transporter of the second processing unit, and
the relay transporter is configured to be accessible to both the second position of the substrate transporter of the first processing unit and the first position of the substrate transporter of the second processing unit.

8. The substrate processing apparatus according to claim 1, wherein the processing transporter of the first processing unit, the relay transporter, and the processing transporter of the second processing unit are arranged at equal intervals.

9. The substrate processing apparatus according to claim 8, wherein each of the first processing unit and the second processing unit comprises a plurality of surface-processing modules, and the plurality of surface-processing modules of the first processing unit and the plurality of surface-processing modules of the second processing unit are arranged at equal intervals.

10. The substrate processing apparatus according to claim 9, wherein the arrangement intervals of the processing transporter of the first processing unit, the relay transporter, and the processing transporter of the second processing unit are the same as the arrangement intervals of the plurality of surface-processing modules of the first processing unit and the plurality of surface-processing modules of the second processing unit.

11. The substrate processing apparatus according to claim 1, wherein the processing transporter is configured to transport the substrate to the cleaning module before transporting the substrate to the surface-processing module.

12. The substrate processing apparatus according to claim 1, wherein the relay transporter is configured to transport the substrate from the cleaning module to the drying module.

13. The substrate processing apparatus according to claim 1, wherein the relay transporter is configured to be accessible to both the surface-processing module of the first processing unit and the surface-processing module of the second processing unit.

14. The substrate processing apparatus according to claim 13, wherein a distance from the relay transporter to the surface-processing module of the first processing unit is the same as a distance from the relay transporter to the surface-processing module of the second processing unit.

15. The substrate processing apparatus according to claim 1, wherein the relay transporter is configured to be accessible to both the cleaning module of the first processing unit and the cleaning module of the second processing unit.

16. The substrate processing apparatus according to claim 15, wherein a distance from the relay transporter to the cleaning module of the first processing unit is the same as a distance from the relay transporter to the cleaning module of the second processing unit.

17. The substrate processing apparatus according to claim 1, further comprising an operation controller configured to control operations of the first processing unit and the second processing unit, the operation controller being configured to:
calculate a first maintenance index value related to maintenance of a consumable in the first processing unit and a second maintenance index value related to maintenance of a consumable in the second processing unit;
predict a maintenance time of the first processing unit and a maintenance time of the second processing unit based on the first maintenance index value and the second maintenance index value; and
when the predicted maintenance time of the first processing unit overlaps with the predicted maintenance time of the second processing unit, change an operating rate of at least one of the first processing unit and the second processing unit such that the predicted maintenance time of the first processing unit does not overlap with the predicted maintenance time of the second processing unit.

18. The substrate processing apparatus according to claim 17, wherein the operation controller is configured to increase the operating rate of the first processing unit, or lower the operating rate of the second processing unit, or increase the operating rate of the first processing unit and lower the operating rate of the second processing unit when the maintenance time of the first processing unit is expected to be reached before the maintenance time of the second processing unit.

19. The substrate processing apparatus according to claim 17, wherein the operation controller is configured to increase the operating rate of the second processing unit, or lower the operating rate of the first processing unit, or increase the operating rate of the second processing unit and lower the operating rate of the first processing unit when the maintenance time of the second processing unit is expected to be reached before the maintenance time of the first processing unit.

20. A substrate processing apparatus comprising:
a first processing unit, a second processing unit, and a third processing unit each configured to process a substrate;
a first relay transporter configured to transport the substrate between the first processing unit and the second processing unit; and
a second relay transporter configured to transport the substrate between the second processing unit and the third processing unit,
wherein each of the first processing unit, the second processing unit, and the third processing unit comprises:
a surface-processing module configured to perform surface processing on the substrate;
a cleaning module configured to clean the substrate;
a drying module configured to dry the cleaned substrate;
a substrate transporter extending from one side to opposite side of each processing unit, and
a processing transporter configured to transport the substrate from the substrate transporter to the surface-processing module, and from the surface-processing module to the cleaning module,
wherein the surface-processing module of one of the first processing unit, the second processing unit, and the third processing unit is any one of:
a CMP module configured to chemically mechanically polish a surface of the substrate;
a bevel polishing module configured to polish a peripheral edge of the substrate;
a partial polishing module configured to polish a portion of the surface of the substrate;
a backside polishing module configured to polish a backside of the substrate; and
a thinning module configured to thin the substrate by grinding the substrate,
wherein the surface-processing module of other one of the first processing unit, the second processing unit, and the third processing unit is any one of:
the CMP module;
the bevel polishing module;
the partial polishing module;
the backside polishing module; and
the thinning module, and
wherein the surface-processing module of remaining one of the first processing unit, the second processing unit, and the third processing unit is any one of:
the bevel polishing module;
the partial polishing module;
the backside polishing module; and
the thinning module.
